(19) United States
(12) Patent Application Publication
(10) Pub. No.: US 2026/0330374 A1
(43) Pub. Date: Oct. 22, 2026

(54) SYSTEMS AND METHODS FOR CYBER RISK LOSS DISTRIBUTION CHARACTERIZATION FOR VARIOUS SCALE DELIVERY DRONE SYSTEMS

(71) Applicants: Stefano Chiaradonna, Tempe, AZ (US); Petar Jevtic, Chandler, AZ (US); Nicolas Lanchier, Mesa, AZ (US)

(72) Inventors: Stefano Chiaradonna, Tempe, AZ (US); Petar Jevtic, Chandler, AZ (US); Nicolas Lanchier, Mesa, AZ (US)

(73) Assignee: Arizona Board of Regents on Behalf of Arizona State University, Tempe, AZ (US)

(21) Appl. No.: 19/309,382

(22) Filed: Aug. 25, 2025

Related U.S. Application Data
(60) Provisional application No. 63/686,757, filed on Aug. 24, 2024.

(51) Int. Cl. G06Q 10/0635; H04L 9/40

(52) U.S. Cl. CPC G06Q 10/0635; H04L 63/1433

(57) ABSTRACT

A computer-implemented system evaluates effects of potential threats (cyber-attacks/hacking, weather hazards, etc.) that may result in damage to a drone fleet and supporting structures, conditioned on physical configurations and parameters of the drone fleet in addition to communication protocols and a surrounding spatial environment. The system accesses drone network information and applies a simulation model to simulate network operations through a Markov chain process that records and aggregates potential losses from cyberattacks on drones, including property damage related to spatial locations of drones and contagion propagation related to spatial locations of nodes and communication protocols used by various components of the network. The system provides outputs usable for a variety of remedial actions, including, for example, reconfiguration of network protocols, modification of drone fleet composition or pathing (e.g., selecting smaller drones), adjustment of insurance risk models, or other operator-selected actions.

### CROSS-REFERENCE TO RELATED APPLICATIONS

This is a U.S. Non-Provisional Patent Application that claims benefit to U.S. Provisional Patent Application Ser. No. 63/686,757 filed Aug. 24, 2024, which is herein incorporated by reference in its entirety.

### GOVERNMENT SUPPORT

This invention was made with government support under 2000792 awarded by the National Science Foundation. The government has certain rights in the invention.

### FIELD

The present disclosure generally relates to computer-implemented drone fleet security management systems, and in particular, to a system and associated method for cybersecurity risk loss distribution characterization for various scale delivery drone systems.

### BACKGROUND

Thousands of commercial drone deliveries are occurring daily worldwide, mainly in the U.S. and China. Global corporate efforts such as the recent Amazon trials at College Station, TX, authorized by the FAA, are poised to make this activity ubiquitous. The potential various-scale applications will lead to substantial cyber risk exposure of deployed drone networks leading to cyberattacks such as hijacking and signal disruption, as evidenced by recent military applications. Thus in the commercial realm, these attacks may result in substantial financial losses from costly property damages. The limited availability of relevant historical losses presents a significant challenge in anticipating and mitigating these risks.

It is with these observations in mind, among others, that various aspects of the present disclosure were conceived and developed.

### BRIEF DESCRIPTION OF THE DRAWINGS

FIGS. 1A and 1B are a pair of graphical representations respectively showing an example “drone swarm” network topology (FIG. 1A) and an example “out-of-range” network topology (FIG. 1B) having n=6 number of cell towers, each with a range of [0, m] random number of drones, where black vertices represent cell towers, white vertices represent drones, solid edges (cell tower-cell tower) are independently open with probability p, and dashed edges (tower-drone and drone-drone) are independently open with probability q;

FIG. 2 is a graphical representation showing a county-level map of a location that was used as a case study for development of the systems outlined herein, in particular showing a county-level map of Texas with the location of College Station within Brazos County and with notable cities for geographical reference;

FIGS. 3A and 3B are a pair of graphical representations showing house centroids and cell tower locations (FIG. 3A) within College Station, TX and a corresponding kernel density of house centroids within College Station (FIG. 3B) used within a case study for development of the systems outlined herein;

FIGS. 4A and 4B are a pair of graphical representations showing example outputs of a system outlined herein, including expected loss (FIG. 4A) and deviation of loss (FIG. 4B) as a function of edge contagion probability between drones (q) for various values of edge contagion probability between cell towers (p) (where drones per cell tower follows [k₀, k₁, k₂, k₃]=[0, 0.4, 0.4, 0.2], cost structure and communication range are in Table 3 and Table 4, respectively, and simulation results are based on one million simulations with assumptions t=1 and λ=1);

FIGS. 5A-5F are a series of graphical representations showing simulated Poisson point patterns and their corresponding density maps, where FIGS. 5A and 5B respectively illustrate a simulated point pattern and corresponding density map for Scenario I, FIGS. 5C and 5D respectively illustrate a simulated point pattern and corresponding density map for Scenario II, and FIGS. 5E and 5F respectively illustrate a simulated point pattern and corresponding density map for Scenario III;

FIGS. 6A-6D are a series of graphical representations showing expectation of loss/cost and deviation of loss/cost for varying cellular-to-drone and drone-to-drone ranges (FIG. 6A shows expectation of loss for cellular-to-drone, FIG. 6B shows deviation of loss for cellular-to-drone, FIG. 6C shows expectation of loss for drone-to-drone, and FIG. 6D shows deviation of loss for drone-to-drone) with varying edge contagion probabilities considered and where simulation results are based on one million simulations with assumptions t=1 and λ=1;

FIG. 7 is a simplified block diagram showing a computational framework for simulating losses of a drone delivery fleet due to cyberattacks outlined herein; and

FIG. 8 is a simplified block diagram showing an example computing device for implementation of a drone risk assessment framework outlined herein.

Corresponding reference characters indicate corresponding elements among the view of the drawings. The headings used in the figures do not limit the scope of the claims.

### DETAILED DESCRIPTION

A computer-implemented system disclosed herein models effects of potential threats (cyber-attacks/hacking, weather hazards, etc.) that may result in damage to a drone fleet and supporting structures, conditioned on physical configurations and parameters of the drone fleet in addition to communication protocols and a surrounding spatial environment. In an example implementation, the system accesses drone network information and applies a simulation model that simulates network operations through a Markov chain process that records and aggregates potential losses from cyberattacks on drones. The simulation model quantifies potential financial losses and other issues associated with drone malfunction, such as a loss distribution according to the mean and variance of the entire drone network. The system may provide outputs usable for a variety of remedial actions, including, for example, reconfiguration of network protocols, modification of drone fleet composition or pathing (e.g., selecting smaller drones), adjustment of insurance risk models, or other operator-selected actions.

Features of the systems outlined herein include stochastic models describing a network of interactions between cellular towers and drones, taking into account geometric constraints imposed by communication protocols in drone delivery networks, property density corresponding to potential drone locations at time-of-attack, and damage estimates conditioned on physical attributes of drones as well as spatial locations at which a compromised drone may fall. Further, the systems outlined herein streamline the computational process by focusing on final destinations for drones, thereby eliminating the need to model an entire pathway of each drone. In addition, the systems outlined herein are generalized to two types of drone delivery networks for the model: drone-swarm model (swarms of drones can establish bidirectional communication within each cluster) and out-of-range model (drones establish short-range communication with each other, rely on cellular towers for communication).

The present disclosure describes a structural model of an aggregate loss distribution for the cyber risk of drone delivery operations on a random spatial network. We contextualize the problem in the probabilistic graph-theoretical framework using bond percolation models and simulated spatial point processes. By characterizing the loss distribution, we allow for the further utility of pricing cyber risk for small, medium, and large-scale drone fleets.

### 1. Introduction

### 1.1 Motivation

Growth of drone delivery operations. In 2022 alone, more than 2000 commercial drone deliveries were occurring every day worldwide (Cornell et al., 2023). In recent years, the global drone package delivery market has experienced remarkable growth, with its value reaching $32.5 billion in 2023 (Global Market Insights, 2024). The future prospects of this industry are exceedingly promising as projections indicate a significant surge in its market value. In fact, by 2032, the drone package delivery market is anticipated to skyrocket to a staggering $78.5 billion (Global Market Insights, 2024). This expected exponential growth can be attributed to several factors, including advancements in drone technology, reduced costs, increasing consumer demand for faster and more efficient deliveries, and the development of supportive regulatory frameworks, such as those of the Federal Aviation Administration (FAA). Also, the growth of drone deliveries can be attributed in part due to its energy efficiency. Drones are battery operated and compared to traditional transportation, such as trucks, offer a more environmentally friendly alternative to deliveries by having significant gains in reducing greenhouse gas emissions (Rodrigues et al., 2022). As the prospect of achieving a net neutral carbon economy gains momentum (Linga, 2022), drone deliveries are increasingly being explored for diverse applications across different scales.

### 1.1.1 Various Scale Drone Applications

Small-and-medium business opportunities. Small and medium-sized enterprises (SMEs) are increasingly capitalizing on the versatility of drones, utilizing them for a range of purposes such as aerial photography (Pilot Institute, 2020), home inspections (Forstadt, 2021), filmmaking, and product deliveries (Joshi, 2021). By integrating drones into their operations, these businesses optimize efficiency, reduce costs, and gain a competitive edge in their respective industries. For example, in 2014, a local florist in Detroit, MI delivered flowers via drone (Vis, 2014). In another instance, in 2020, Mockingbird Cafe, a small cafe located in Christiansburg, Virginia, utilized drone technology for local deliveries (Fox, 2020). In 2023, other restaurants, including Nekter Juice Bar, Tokyo Joe's, and MAD Greens in Mesa, AZ, are also incorporating drones into their food delivery services (Fontanez, 2023). Some estimates show that implementing drone delivery has the potential to generate an annual revenue increase of over $176,000 within five years for similar full-service cafes in the region (Lyon-Hill et al., 2020). Freelancers, including photographers and videographers, often deploy their drones in different locations (Vujičić et al., 2022). Beyond the U.S., drone delivery services in India focused their role in accessible healthcare (UAS News, 2023), local florist shops in Malaysia (Prabha, 2022), and Japanese grocery stores (Kameda, 2023).

Large-scale drone deliveries. When it comes to large-scale implementation of drone delivery services, three prominent industry stakeholders have stepped to the fore: Google, Walmart, and Amazon. Specifically, in 2022, Walmart made more than 6000 deliveries across seven U.S. states (Walmart, 2023). Similarly, Google, through its subsidiary Wing, has been at the forefront of drone delivery innovation. With successful pilot programs in Australia and the United States, Wing has demonstrated the viability and efficiency of using drones for last-mile deliveries (Vincent, 2021). In May 2023, Google's Wing has achieved a significant milestone by completing 300,000 commercial drone deliveries across the U.S., Europe, and Australia (Hughes, 2023). More recently, Amazon Prime Air has entered the drone delivery market with hundreds of deliveries underway (Tarasov, 2023) both within the U.S. and internationally (Amazon, 2023). Unfortunately, while drone deliveries offer increasing and exciting opportunities for various-scale businesses, they also come with a plethora of associated risks.

### 1.1.2 Risks

Drone deliveries are fraught with risks from physical, weather hazards, and those cyber-related threats. For physical risks, one significant concern is the potential for deliberate interference by individuals. Instances of people using firearms to shoot down drones have been reported (see e.g. Lee, 2020), posing a threat not only to the delivery itself but also to people in the vicinity. Such actions can lead to property damage (Bertrand et al., 2018) and bodily injury (Pang et al., 2022; Sehrawat, 2018). Additionally, there is a risk of accidents occurring due to technical malfunctions or unforeseen circumstances, such as drones colliding with structures (Watkins et al., 2020), power lines (Wesoff, 2017), or even animals, such as birds (Giggs, 2019). Furthermore, natural hazards pose significant challenges to drone delivery systems. The unpredictable and adverse weather conditions, such as strong winds, heavy rain, or severe storms, can destabilize drones in flight, potentially leading to drones plummeting to the ground and their destruction (Aiello et al., 2020; Thibbotuwawa et al., 2020).

Finally, drone delivery systems are not immune to cybersecurity risks, presenting unique challenges that must be addressed to ensure the integrity, privacy, and safety of these operations. One of the primary concerns is the potential for unauthorized access to the drones' control systems and communication disruptions (Giray, 2013; Javaid et al., 2012; Kerns et al., 2014; Krishna & Murphy, 2017). Hackers may attempt to intercept or manipulate communication signals between the drone and the ground control station, leading to unauthorized control, rerouting, or even theft of the drone and its payload (He et al., 2016; Su et al., 2016; Tsao et al., 2022). Another significant risk is the possibility of data breaches, as drones often gather and transmit sensitive information, such as housing data during their delivery routes (Sedjelmaci et al., 2016). While many of the cyber attacks on drones have been related to military conflicts (see e.g. Hartmann & Steup, 2013), there have been reports of civilian drones being hacked (see e.g. Cebeloglu & Karakose, 2019). Such aggressive cyberattacks could lead to monetary losses, physical injuries, and, in severe instances, fatalities (Alexandre et al., 2023). That is why the loss exposure from cyberattacks remains a significant concern for drone risk underwriting (Kwon & Cheung, 2022; Tarr et al., 2021).

### 1.1.3 Insurance Coverage for Drones

The global drone insurance market was valued at $1.1 billion in 2023 and is expected to grow to $2.6 billion by 2032 (Allied Market Research, 2024). Currently, drone insurance typically includes first-party liability coverage for damage to the drone, and third-party liability for bodily injury and property damage (Allied Market Research, 2024; American International Group, 2024; Tarr et al., 2021). Some notable insurers that offer these coverages for drones include SkyWatch (SkyWatch, 2024), CNA (CNA, 2019), United States Aircraft Insurance Group (United States Aircraft Insurance Group, 2024), American International Group (American International Group, 2024), and AVION Insurance (AVION Insurance, 2024). In addition, policies provide a diverse range of additional coverage options, enabling the insured to choose which ones to incorporate. For instance, AIG offers coverage for drone hijacking in the event of a cyber attack (American International Group, 2024). Similarly, AVION Insurance provides payload coverage for any damage that may occur to the items carried by the drone (AVION Insurance, 2024). Overall, these diverse insurance offerings highlight the multifaceted aspects of drone insurance and the associated emerging risks as drone technology evolves.

### 1.1.4 Interrelated Nature of Drones

The above-mentioned cyber risks are magnified with the emergence of drone swarms. A drone swarm refers to a cluster of drones that can collaborate independently with minimal human intervention to perform collective tasks over extensive geographic regions (Asaamoning et al., 2021; Wang et al., 2019). In drone delivery operations, for example, a swarm of drones collaborates by efficiently distributing tasks, such as data sharing of obstacles in the environment, among themselves based on several factors, such as proximity to delivery locations, battery life, and payload capacity (Asaamoning et al., 2021; Wang et al., 2019). Through coordinated navigation and communication protocols (Verma et al., 2021), this collaborative coordination among the swarm of drones creates shared cyber risks, amplifying the severity of a cyberattack that could impact multiple drones simultaneously. Consequently, this elevates the overall risk exposure and interconnected losses. This phenomenon mirrors the interconnected nature observed in companies, such as hotel chains or supply chain networks, where cyberattacks affecting one entity can have cascading losses across the entire network. This area of research has increasingly become more important to model for the insurance and cyber risk management community (Eling et al., 2023; Welburn & Strong, 2022). Hence, our model characterizes the loss distribution via mean and variance of the entire drone network rather than solely on individual drones. This study underscores the critical need for comprehensive insurance coverage and a unique risk modeling approach that addresses the severe cyber risks associated with complex drone operations.

### 1.2. Literature Review

Cybersecurity of drones: In response to those concerns, in the past decade, there have been a growing number of works exploring the cybersecurity risks of drones (Fouda, 2018; Krishna & Murphy, 2017; Ly & Ly, 2021; Madan et al., 2019). For instance, Hartmann and Steup (2013) were among the first to attempt to comprehensively describe cyber risk assessment, particularly focusing on military drones. Their work laid the groundwork for subsequent studies that delved into specific threats and vulnerabilities associated with drone technology. Addressing the evolving landscape of cybersecurity threats, there have been works that investigate cyber-security threats of drones and provide proactive cybersecurity measures (see e.g. Baig et al., 2022; Basan et al., 2021; Tran et al., 2022; Yaacoub et al., 2020). In addition, works, such as Alexandre et al. (2023), provide a comprehensive overview of cybersecurity risk assessment models and cyber vulnerabilities related to drones. In the context of the above references, this work encapsulates and synthesizes the collective knowledge accumulated from prior studies, offering a consolidated perspective on the evolving landscape of drone cybersecurity. In each of these papers, a clear relationship between cybersecurity and safety was identified. Because of this, there have been numerous works and growing works on assessing the ground impacts of drone failure (Donkels, 2020; la Cour-Harbo, 2017,2020). However, in the case of drone loss distributions, especially those related to cyber aspects, there is a critical gap in research. This underscores the need for further exploration in understanding and quantifying the risks associated with drone losses, particularly in the context of cybersecurity.

Cyber risk modeling: The above-mentioned critical research gap is further exhibited in the literature for cyber risk modeling. For example, there has been extensive research investigating the statistical and stochastic characteristics of cyber risk pertaining to data breaches (Antonio et al., 2021; Eling & Loperfido, 2017; Farkas et al., 2021; Maillart & Sornette, 2010). Furthermore, the numerous and, although, comprehensive reviews of cyber risk tend to lack the modeling and pricing of cyber risk of drones (see e.g. Awiszus et al., 2023; He et al., 2024). While there have been works that price the flight of a single drone without relying on past accident rates (Rubio-Hervas et al., 2020), they do not consider the interrelated nature of losses of cyber risk for multiple-drone deployment. In particular, (Biener et al., 2015) emphasized the distinctive characteristics of cyber risks compared with other operational risks and illustrated significant insurability problems resulting from interrelated losses. From a statistical perspective, there have been works that investigated the cross-sectional dependence of interrelated cyber risks (Eling & Jung, 2018; Liu et al., 2022). For example, some works evaluated the impact of cyber risk across insurance portfolios (Herath & Herath, 2011) and industry sectors (Eling et al., 2023; Welburn & Strong, 2022). However, the limited availability of high-quality data concerning cyber attacks and drone losses poses a significant barrier to the effective utilization of statistical modeling in assessing emerging cyber risk domains and interrelated losses. Moreover, relying solely on statistical modeling may not afford a thorough comprehension of the intricate mechanisms underlying cyber risk interdependence. This highlights the need for adopting a probabilistic approach to characterize cyber losses stemming from the propagation of contagious cyber attacks across networks.

To address this need for a probabilistic approach, the existing literature has leveraged differing tools for modeling cyber loss from the contagious cyberattack on a network. For instance, some studies have utilized L-hop propagation (Da et al., 2021), epidemiological models (Fahrenwaldt et al., 2018; Xu & Hua, 2019), or attack graphs (Chen et al., 2024; Kazeminajafabadi & Imani, 2023; Wang et al., 2018). However, these models have some shortcomings in cyber risk modeling, such as the limited propagation depth of L-hop propagation (Da et al., 2020,2021), and the inefficiency of attack graphs as networks increase in size (Al-Araji et al., 2021). In contrast, a percolation model does not suffer from these shortcomings, as it can effectively handle networks of increasing size and deeper propagation (Moore & Cho, 2019). Additionally, some works have applied percolation theory to characterize the loss distribution of cyber risk (Chiaradonna & Lanchier, 2022; Chiaradonna et al., 2023; Jevtić and Lanchier, 2020a). However, none of the above-mentioned works investigated the cyber risk of drone delivery networks. Therefore to address this gap of research, we propose a dynamic structural framework for cyber risk loss assessment of a drone delivery network. Until drone delivery operators, such as Amazon, accumulate substantial historical data reflecting the continuous shifts in environmental factors across their extensive delivery zones, conventional risk-related pathing methods may struggle to address the inherent stochasticity and heterogeneity of these environments. While existing literature has explored drone paths for risk assessments (see e.g. Hu et al., 2020; López et al., 2021), the focus has predominantly been on small-scale operations involving a single drone or limited spatial extents, such as specific city areas. The emerging trend of drone deliveries, however, spans a diverse range of applications, often requiring coverage of larger areas or deploying large-scale drone fleets. Moreover, the operational landscape for drone deliveries is dynamic, with consistent environmental changes, such as the emergence of new buildings or alterations in zoning laws.

### 1.3 Contributions of the Present Disclosure

To address these challenges, our innovative framework introduces a distinctive method that prioritizes the final locations of drones. This strategy not only furnishes drone delivery companies and their users with a more adaptable risk management tool but also offers insurers a versatile solution. Importantly, this solution does not require an exhaustive comprehension of the intricate details of the entire drone path, details that may be inaccessible due to proprietary data restrictions imposed by the drone operator. In contrast, the system operates effectively with incomplete telemetry, making it deployable in proprietary networks.

To model the spread of a cyberattack on the drone delivery network, we adopt a contagion process to model the propagation of a cyberattack within a network. A drone delivery network is comprised of drones that are spatially distributed across geographical areas that encompass the delivery service region, comprising an airspace corridor and delivery areas. The cyberattack is initiated from a randomly selected node and spreads outward along compromised edges. By utilizing bond percolation, a concept linked to cyber resilience through its consideration of stochasticity and network structure (Jevtić and Lanchier, 2020a; Moore & Cho, 2019), we establish a relevant perspective for drone fleet operators, planners, drone and aircraft policy-makers, cybersecurity experts, network specialists, actuaries, and drone delivery-stakeholders. Taking into account the random costs associated with each drone, the loss resulting from the cyberattack is defined as the cumulative cost of all the nodes affected by the contagion. Consequently, this research aims to bridge the knowledge gap by presenting a cyber risk loss model applicable to a random network, such as a drone delivery network, where the contagion spreads throughout the internal network.

In this setting, we provide analytical and simulated results related to the mean and standard deviation of the aggregate loss distribution for multiple cyberattacks. As such, this work paves the way for risk management solutions and drone-insurance pricing. While the main focus is cyber-related risks, our developed methodology can be applied to the other types of risks as well.

The rest of this paper is organized as follows. In Section 2, the communication networks of drone delivery operations are discussed. In Section 3, the mathematical framework of the aggregate loss due to cyberattacks on drone delivery operations is developed. Section 4 presents the analytical results of the mean and variance of the loss distribution, while Section 5 presents the proofs. Section 6 provides the context and background of our framework of drone delivery operations in College Station, TX. Section 7 presents the numerical results. Section 8 provides further discussion of the results and methods. Section 9 outlines a computer-implemented framework and devices for implementation of the concepts outlined herein.

### 2. Multi-Layered Drone Delivery Communication Systems

### 2.1 Drone Fleet Communication Protocols

In this section, we provide an overview of the prominent communication networks commonly utilized in drone delivery operations. This provides the background of the model description of the random-graph for the drone delivery network in Section 3. Complex wireless communication networks are crucial for the long-term success of various-scale drone delivery operations, as they play a vital role in ensuring safety and reliability. Effective communication facilitates the seamless flow of data within the drone network, enabling efficient information distribution, sharing, and enabling global analysis and decision-making processes (Wang et al., 2019). In the following section, we will explore several prominent communication networks commonly utilized in drone delivery operations.

Cell tower-to-cell tower. In an urban environment, cell towers communicate with each other, exchanging information such as signal strength and traffic load (Ahamed & Faruque, 2021; Bello et al., 2018; Koutsaftis et al., 2019). This bidirectional communication allows for a smooth handover of mobile devices, such as drones, from one tower to another within a coverage area (Zeng et al., 2022). Cell towers in urban areas communicate wirelessly using protocols like cellular and microwave links (Ahamed & Faruque, 2021; Ogulenko et al., 2021). These connections allow data and voice exchange, facilitating smooth handovers as users move between towers (Zeng et al., 2022). Towers continuously share information on signal strength and traffic load, optimizing network performance and enhancing user experience (Ahamed & Faruque, 2021; Bello et al., 2018; Koutsaftis et al., 2019). Interconnections between towers may be wired or wireless, such as 4G (Amzallag et al., 2012).

Drone-to-cell tower. Cellular connectivity has emerged as a crucial element for drone delivery operations, encompassing both 4G and 5G technologies (Asaamoning et al., 2021; Geraci et al., 2022; Guirado et al., 2021; Ivancic et al., 2019; Mozaffari et al., 2019; Rovira-Sugranes et al., 2022; Sharma et al., 2020; Verma et al., 2021; Zhang et al., 2018). However, drone-to-cell tower connectivity can be affected by wireless coverage availability and cellular technology limitations, such as 4G covering up to 16 km and 5G typically extending up to 1 km (Farooq et al., 2022; Koulouris et al., 2023; Zou et al., 2017). Cellular connectivity, including 4G and 5G, is vital for drone delivery, enabling drones to connect to cell towers for command and data exchange, such as GPS information (Asaamoning et al., 2021; Zhang et al., 2018). Companies like Walmart design drones with cellular capabilities (Dano, 2023). Overlapping cell coverage often allows drones to switch to the strongest signal to maintain connectivity (Hu et al., 2019; Mishra & Natalizio, 2020). Although satellite links are reliable, they are costly, making cellular the preferred choice for commercial drone operations, particularly over large areas. Drones can also communicate within a swarm.

Drone-to-drone communication: Drone delivery systems increasingly use drone swarms, clusters of drones that autonomously collaborate to perform large-scale deliveries across wide areas (Asaamoning et al., 2021). A drone swarm, as discussed previously, establishes wireless and bidirectional communication among drones in close proximity (Alkouz et al., 2021; Asaamoning et al., 2021; Gharibi et al., 2016; Qadir et al., 2021; Tahir et al., 2019; Verma et al., 2021; Wang et al., 2019), such as Wi-Fi connectivity up to 100 m (Bhatia, 2015; Koulouris et al., 2023). This approach enables drones to adapt to dynamic conditions like obstacles and weather changes, enhancing delivery efficiency (Wang et al., 2019). Drones in a swarm communicate wirelessly via protocols like Wi-Fi, Zigbee, or Bluetooth, though these have limited ranges (e.g., Wi-Fi up to 100 m, Bluetooth up to 10 m) (Bhatia, 2015; Koulouris et al., 2023).

In summary, the geometry and topology of the drone delivery network, including range and signal strength, is dependent on the chosen communication protocol. The geometric network refers to the physical arrangement of the drones and their relative positions in three-dimensional space, while the topological network focuses on the logical connections between the drones. The communication protocol governs how drones exchange information and signals, influencing factors such as communication range, signal quality, and the ability to maintain a stable connection. Additionally, the presence of obstacles like buildings can limit the range and signal strength of these connections, affecting their overall effectiveness (Alsamhi et al., 2021). Therefore, the cybersecurity of the drone delivery network is critical, especially as drones utilize differing protocols during their flights. Due to the presence of cyber threats, it is essential to assess and measure the potential cyber risks within drone delivery networks.

### 2.2 Cyber Risk of Drone Communication Networks

### 2.2.1. Drone Networks

Infection. The spreading of malware in drone networks poses significant technical challenges and potential risks. Malware can infiltrate these networks through various vectors, such as compromised ground control stations, infected software updates (Yaacoub et al., 2020), injecting wrong data (Yampolskiy et al., 2013), or even direct physical access to the drones themselves. Once introduced, malware can propagate rapidly, exploiting vulnerabilities in communication protocols, onboard systems, or autonomous flight control algorithms (Maurin Saldaña et al., 2022). It can manipulate sensor data, compromise the integrity of flight plans, or hijack command and control channels, leading to unauthorized access and control over drones. Additionally, malware can exploit shared resources within the network, allowing it to infect other drones and amplify its impact (Maurin Saldaña et al., 2022).

Jamming: GPS spoofing attacks. GPS spoofing is the manipulation of GPS signals to deceive drones and disrupt their navigation (Khan et al., 2021). This threat allows attackers to provide false location data, redirecting drones from their intended paths, potentially leading to unauthorized access or collisions (Giray, 2013; Qiao et al., 2017). GPS spoofing can also enable hijacking by disabling normal drone operations (Tsao et al., 2022). Incidents include a 2011 military drone capture and a 2012 civilian crash due to GPS jamming, highlighting ongoing risks for both military and civilian drone uses (Lee et al., 2012; Yağdereli et al., 2015).

Wi-Fi jamming. Wi-Fi jamming for drones involves intentionally disrupting or interfering with the wireless communication signals used by drones to establish connections and transmit data. Hackers employ specialized devices or techniques to interfere with the Wi-Fi signals, effectively blocking or jamming the drone's ability to maintain a stable connection with its remote controller or ground station (Westerlund & Asif, 2019; Yaacoub et al., 2020). Another potential form of attack is the creation of a fake Wi-Fi access point, which lures drones to connect to a malicious nearby network. This interception method allows hackers to manipulate and take control of other drones by connecting a device to a targeted drone and programming it to intercept and hijack nearby drones (Yaacoub et al., 2020). Consequently, the compromised drone acts as a rogue Wi-Fi access point for other drones in proximity, enabling the injection and spread of malware into the connected drones (Westerlund & Asif, 2019; Yaacoub et al., 2020).

### 2.2.2 Communication Protocols

Cellular: The integration of cellular networks, such as 4 G, 5 G, and emerging 6 G, into drone operations enhances remote control, real-time data transmission, and communication but introduces cybersecurity risks (Fotouhi et al., 2019; Siriwardhana et al., 2021; Vargas & Tien, 2022). A primary concern is unauthorized access, allowing malicious actors to control drones, disrupt operations, or intercept sensitive data (Cybersecurity and Infrastructure Security Agency (CISA), 2021). Cyberattacks on cellular networks can disrupt drone behavior, with cascading service outages if towers fail or are attacked (Lee & Wang, 2023). Cell towers face hacking risks that expose nearby devices to data breaches and malware, especially from fake towers that mimic real ones (Huang & Wang, 2018; Traynor et al., 2009). In fact, there has been a history of hackers using fake cell towers to spread malware to connected devices (Cimpanu, 2017; Muncaster, 2017; Zetter, 2011), intercepting sensitive data (Zetter, 2010).

Wi-Fi. Wi-Fi connectivity has become an integral part of drone networks, enabling seamless communication and control between drones and ground stations. However, this convenience comes with inherent cybersecurity risks that need to be addressed. One of the primary concerns is unauthorized access to the Wi-Fi network, as malicious actors may attempt to intercept or manipulate drone communications, leading to unauthorized control or data breaches. Weak or easily guessable Wi-Fi passwords, outdated encryption protocols, and insufficient network segmentation can make drone networks vulnerable to such attacks. Additionally, as discussed above, Wi-Fi signals can be easily jammed or disrupted (Arana, 2006), leading to a loss of control over drones. Malware can propagate through direct pair-wise communications e.g. Wi-Fi and Bluetooth (Gour et al., 2014).

Bluetooth: The use of Bluetooth technology in drone networks expands the possibilities of drone communication networks, providing a convenient wireless connection for drones. However, this adoption of Bluetooth technology also exposes drone networks to substantial cybersecurity risks (Nguyen & Nguyen, 2021). Unauthorized access and control over drones pose a major concern, especially when Bluetooth connections are not adequately secured (Antonioli et al., 2020).

### 3. Cyber Risk Model of Drone Delivery Network

This section details the description of the developed stochastic model for the characterization of the aggregate loss distribution for various-scale drone delivery networks. In particular, our model characterizes a continuous Markov chain process denoted by (Lₜ), which systematically records and aggregates losses stemming from all cyberattacks transpiring up to a predetermined fixed time t. For the purpose of loss assessment, the primary aim of this investigation is to calculate the mean and variance of the stochastic process Lₜ for a drone delivery network. In this work, we derive upper bounds for the mean, and for analytical tractability, the variance will be assessed using simulation-based methodology.

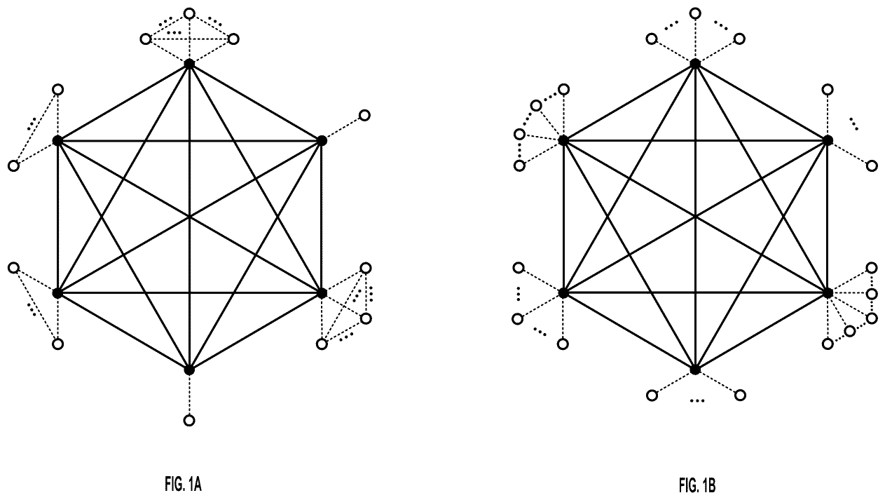

Motivated by the aforementioned communication network in Section 2, the proposed drone delivery network comprises two overlaying topological network models: the drone-swarm model and the out-of-range model. Both models assume that all cell towers within the network are interconnected in a complete mesh network, based on the geometric assumption that there are no structural interferences like buildings hindering communication connectivity. In this setting, the primary distinction between the drone swarm and out-of-range models lies in the connectivity among the drones. In the drone swarm model (see FIG. 1A), swarms of drones can establish bidirectional communication within each cluster using short-range technologies, such as Wi-Fi, representing a mesh network (see Asaamoning et al., 2021). Conversely, in the out-of-range model (see FIG. 1B), drones are unable to establish direct short-range communication with each other and must rely on cellular towers for communication, representing a star network (see Asaamoning et al., 2021).

Therefore, our topological models take into account the geometric constraints imposed by communication protocols in drone delivery networks, particularly those related to the drones themselves:

Model description. The main component of our stochastic models is the network of interactions describing how the towers and the drones communicate. The network includes n towers, labeled 1, 2, . . . , n, all connected to each other to form a complete graph Kₙ. In addition:
1. for all x=1, 2, . . . , n, there are Dₓ drones flying around tower x where the Dₓ are random variables following the same distribution D with range {0, 1, 2, . . . , m}.
2. Tower x and its Dₓ drones form another graph that we denote by Ĝₓ. We consider two different graphs, one for each of the two models.
3. In the drone swarm model, the graph Ĝₓ is the complete graph with Dₓ+1 vertices.
4. In the out-of-range model, the graph Ĝₓ is the star with Dₓ branches and center x.

The construction of these two models results in a random network G_{n,D} with:

$$( {D}_{1} + 1 ) + ( {D}_{2} + 1 ) + … + ( {D}_{n} + 1 ) = n + {D}_{1} + {D}_{2} + … + {D}_{n}$$

vertices, and we refer to FIGS. 1A and 1B for respective visualizations of this network for the drone swarm model and the out-of-range model. Each vertex is also attributed a random monetary value that we call cost. More precisely, each tower x has a cost Cₓ with distribution C to consider financial losses from the operational degradation of a cyberattack, such as maintenance and/or repair expenses. In addition, each drone y has a cost C_{y} with distribution Ĉ to account for the financial loss of the drone and/or other losses attributed to the impact of a falling drone, such as property damages. Next, to measure the vulnerability of the network to cyber attacks and model contagion, we also define a bond percolation process on G_{n,D} by assuming that:
5. The edges of [symbol] ₙ are open independently with the same probability p.
6. For x=1, 2, . . . , n, the edges of Gx are open independently with probability q.

Open edges represent vulnerable links in the sense that, in the event of a cyber attack starting from the origin of the contagion o, a vertex of the network, the contagion will spread from the origin of the contagion and through the open edges.

Finally, the times at which cyber attacks strike the network are described by an underlying Poisson process Nₜ with intensity λ, meaning that the times between consecutive cyber attacks are independent exponential random variables with the same parameter λ. The Poisson process is a standard starting point for frequency modeling, especially in the contexts of cyber risk (Eling & Wirfs, 2019; Mikosch, 2004; Skeoch & loannidis, 2024; Xu & Hua, 2019) and cyberattack modeling (Al-Haija, 2021; Nie et al., 2020; Rauta et al., 2015; Riordan et al., 2016). This is due to its analytical tractability and well-established availability of statistical estimation techniques, especially in actuarial applications for cyber risk (Zeller & Scherer, 2024). Moreover, the time gaps between attacks are configured in a way that each attack occurs instantly, yet with a sufficient duration between consecutive cyberattacks. This interarrival time considers the drone fleet to be re-equipped and redeployed. Consequently, our study focuses on cyberattacks targeting a freshly deployed iteration of the drone fleet for each cyberattack. Given that any malfunction or anomalous behavior in the drone would undergo analysis and assessment for maintenance purposes, our modeling choice considers a new drone may be deployed as a replacement.

Using the stochastic components of the models, we can now give a rigorous definition of the aggregate loss. At each arrival time of the Poisson process, we fix a vertex oϵ [symbol] ₙ to be the origin of the attack. Due to symmetry, the particular origin of o is unimportant. Then, having a realization of the bond percolation process, assumed to occur instantly, we write o↔y to indicate that there is a path of open/vulnerable edges connecting o and y, which implies that vertex y is affected by the current cyber attack. Identifying each graph with its vertex set to avoid additional notation, by Cₒ, we denote an infected cluster such that:

$${C}_{o} = \{ y ∈ {G}_{n , D} : o ↔ y \}$$

This cluster represents the set of drones and towers compromised during the cyber attack. Thus, having a realization of the cost topology (the random variables Cₓ and C_{y}), the loss resulting from the cyber attack is the cumulative cost C_{n,D} attached to the infected cluster:

$${C}_{n , D} = {C}_{n} + {\sum }_{x ∈ {𝕂}_{n}} {\hat{C}}_{x} where {C}_{n} = {\sum }_{x ∈ {C}_{0} ⋂ {𝕂}_{n}} {C}_{x} and$$

$${\hat{C}}_{x} = {\sum }_{y ∈ {C}_{0} ⋂ ( {\hat{G}}_{x} ∖ \{ x \} )} {C}_{y} .$$

The aggregate loss of the system at time t is then defined as the sum of the losses resulting from all the cyber attacks that occur before that time.

Finally, we complement our setting with a spatial Poisson point process for the locations of the number of drones. In particular, a spatial point process is characterized by its intensity function, which describes the average number of events, in our case drones, per unit area. For s∈S, let ds be an infinitesimal area in [symbol] ² centered at s and N be the number of drones. Specifically, the intensity is defined as:

$${Λ}_{( s )} = {lim}_{\vert d s \vert \to 0} \frac{E [ N ( d s ) ]}{\vert d s \vert} .$$

Previous works that utilize percolation theory for characterizing the aggregate loss distribution of cyber risk (see e.g. Chiaradonna et al., 2023; Jevtić and Lanchier, 2020b) did not incorporate spatial Poisson point processes to account for the geometric aspects of the environment. Therefore, this work marks a newfound direction and applicability of cyber risk modeling.

TABLE 1
List of assumptions for cyber risk model of drone delivery network.

| | Weight | Wingspan | Flight Range | |
|---|---|---|---|---|
| Drone Models | (kg) | (m) | (km) | Source(s) |
| Wing | 4.80 | 1.00 | 20.00 | (Osinto, 2020) |
| Matternet M2 | 13.15 | 1.27 | 20.00 | (FAA, 2022a; Matternet, 2022) |
| Wingcopter GmbH | 24.04 | 1.98 | 75.00 | (FAA, 2022b; Wingcopter, |
| Model 198 US | | | | 2021) |
| Zipline UAS Sparrow | 20.87 | 3.05 | 16.09 | (FAA, 2022c, e) |
| Flirtey F4.5 Unmanned | 17.24 | 1.98 | 16.09 | (FAA, 2022c) |
| Aircraft | | | | |
| Amazon MK27 | 40.37 | 1.98 | 24.14 | (Tarasov, 2022; Federal |
| | | | | Register, 2022) |

### 4. Main Results

In this section, we demonstrate the mean of the aggregate loss distribution for drone delivery systems as a function of the parameters of the system (i.e., parameters derived from drone telemetry and physical attributes, network topology constraints, communication protocol limits, and geometric/spatial/population characteristics of a geographic region). To be more precise, we demonstrate the upper bound of the mean for two scenarios of drone delivery network formation for the drone swarm and out-of-range scenarios, shown in Theorem 1 and Theorem 2, respectively. The mean loss distribution, along with other distribution characteristics, may be used within a control and planning pipeline for a drone fleet, e.g., to adjust or otherwise set customized policies for drone routing and communication, isolate nodes, allocate bandwidth, or trigger resilience measures.

Theorem 1. (drone swarm). Assume that the number of cell towers and drones infected will be low i.e. (n−2)p<1 and (m−1)q<1, respectively. Then,

$$E ( {L}_{t} ) \leq λ t ( 1 + \frac{( n - 1 ) p}{1 - ( n - 2 ) p} ) ( E ( C ) + {\sum }_{k = 1}^{m} ( \frac{k q}{1 - ( k - 1 ) q} ) P ( D = k ) E ( \hat{C} ) ) .$$

Theorem 2. (out-of-range). Assume that (n−2)p<1. Then,

$$E ( {L}_{t} ) \leq λ t ( 1 + \frac{( n - 1 ) p}{1 - ( n - 2 ) p} ) ( E ( C ) + q E ( D ) E ( \hat{C} ) ) .$$

We point out that, in both theorems, the common factor:

$$( 1 + \frac{( n - 1 ) p}{1 - ( n - 2 ) p} )$$

is an upper bound for the expected number of infected towers that holds if (n−2)p<1. When the inequality is reversed, the contagion becomes supercritical, and there is a positive probability that a large fraction of the towers get infected. In this case, using that the number of infected towers is trivially bounded by n, we still have that

$$E ( {L}_{t} ) \leq λ tn ( E ( C ) + {\sum }_{k = 1}^{m} ( \frac{k q}{1 - ( k - 1 ) q} ) P ( D = k ) E ( \hat{C} ) )$$

for the drone swarm model with (m−1)q<1, and

$$E ( {L}_{t} ) \leq λ tn ( E ( C ) + q E ( D ) E ( \hat{C} ) )$$

or the out-of-range model regardless of the value of m.

### 5. Proof of Theorems 1 and 2

The proof of the two theorems relies on conditioning techniques and branching processes estimates, and can be divided into four steps as follows:
1. Use conditioning to express the expected value of the aggregate loss Lₜ as a function of the expected value of the cost C_{n,D} resulting from a single attack.
2. Use another conditioning to express the expected value of the cost C_{n,D} as a function of the number of infected vertices in the central graph and peripheral graphs.
3. Use the fact that the number of infected vertices in [symbol] ₙ is stochastically smaller than a Galton-Watson branching process to get an upper bound for the number of infected vertices.
4. Compute the expected value of the number of infected vertices in a star subgraph of the mesh network of the drone swarm model and of the star graph of out-of-range model.

The first step above is proved in the next lemma.

Lemma 1. The mean of Lₜ is given by E(Lₜ)=λtE(C_{n,D}).

Proof. Since the costs of consecutive cyber attacks are identically distributed, and conditioning on the number Nₜ of cyber attacks by time t, we obtain:

$$E ( {L}_{t} ) = E ( E ( {L}_{t} \vert {N}_{t} ) ) = E ( {N}_{t} E ( {C}_{n , D} ) ) = E ( {N}_{t} ) E ( {C}_{n , D} ) = λ t E ( {C}_{n , D} ) ,$$

which proves the lemma. □

The analysis of the cost C_{n,D} is more complicated because the cost of a tower and the cost of a drone have different distributions. Due to the difference in distribution, the cost of a single attack depends on the number of infected towers and the number of infected drones (not just the total number of infected components in the system). These two random variables are not independent, which adds to the difficulty of the problem. To begin with, we denote the number of infected vertices in the central graph [symbol] ₙ and in each of the peripheral graphs Ĝₓ by:

$${S}_{n} = \vert {C}_{0} ⋂ {𝕂}_{n} \vert and {\hat{S}}_{x} = \vert {C}_{0} ⋂ {\hat{G}}_{x} \vert .$$

With this construction, we have the total number of infected towers be Sₙ, and the total number of infected drones be Ŝ₁+Ŝ₂+ . . . +Ŝₙ−Sₙ. The next lemma covers the second step above, giving the expected value of the cost, C_{n,D}, as a function of the expected value of the number of infected vertices Sₙ and Ŝₓ.

Lemma 2. The mean of the total cost is

$${E}_{0} ( {C}_{n , D} ) = {E}_{0} ( {S}_{n} ) ( E ( C ) + {E}_{x} ( {\hat{S}}_{x} - 1 ) E ( \hat{C} ) ) .$$

Proof. Conditioning on Sₙ and Ŝₓ, we first get

$${E}_{0} ( {C}_{n} ) = {E}_{0} ( E ( {C}_{n} \vert {S}_{n} ) ) = {E}_{0} ( {S}_{n} E ( C ) ) = {E}_{0} ( {S}_{n} ) E ( C )$$

$${E}_{x} ( {\hat{C}}_{x} ) = {E}_{x} ( E ( {\hat{C}}_{x} \vert {\hat{S}}_{x} ) ) = {E}_{x} ( ( {\hat{S}}_{x} - 1 ) E ( \hat{C} ) ) = {E}_{x} ( {\hat{S}}_{x} - 1 ) E ( \hat{C} ) .$$

Conditioning again on Sₙ, we deduce that

$$\begin{matrix}{E}_{0} ( {C}_{n , D} ) = {E}_{0} ( {C}_{n} + {\hat{C}}_{1} + … + {\hat{C}}_{n} ) = {E}_{0} ( E ( {\hat{C}}_{1} + … + {\hat{C}}_{n} \vert {S}_{n} ) ) \\ = {E}_{0} ( {C}_{n} ) + {E}_{0} ( {S}_{n} {E}_{x} ( {\hat{C}}_{x} ) ) = {E}_{0} ( {C}_{n} ) + {E}_{0} ( {S}_{n} ) {E}_{x} ( {\hat{C}}_{x} ) \\ = {E}_{0} ( {S}_{n} ) ( E ( C ) + {E}_{x} ( {\hat{S}}_{x} - 1 ) E ( \hat{C} ) )\end{matrix} .$$

This completes the proof of the lemma. □

We now focus on the third step described above which, together with the previous two lemmas, will give the upper bound for the expected value of the aggregate loss for the drone swarm model. The goal is to study the number of infected vertices in the complete graph, which is made difficult by the presence of an interaction network (local interactions) inducing a lack of independence and strong spatial correlations. The idea to obtain an upper bound is to observe that the number of infected vertices is dominated by a certain Galton-Watson branching process. More precisely, let X_{g} be the number of vertices in the complete graph [symbol] ₙ that can be reached from the origin o by a path of g open edges. Because the longest path has n−1 edges,

$${S}_{n} = {X}_{0} + {X}_{1} + … + {X}_{n - 1} . \qquad ( 1 )$$

Because the number of open edges in [symbol] ₙ starting from each vertex is Binomial (n−1, p), a standard coupling argument implies that X_{g} is stochastically smaller than the number of individuals at generation g in a Galton-Watson branching process ξ_{g} in which:
1. the first individual has Y₁=Binomial(n−1,p) offspring; and
2. the subsequent individuals have Y₂=Binomial(n−2,p) offspring.

Also, to obtain our upper bounds, we will use that:

X_{g} is stochastically smaller than ξ_{g}. (2)

The mean number of offspring per individual will be denoted by:

$${μ}_{1} = E ( {Y}_{1} ) = ( n - 1 ) p and {μ}_{2} = E ( {Y}_{2} ) = ( n - 2 ) p .$$

Using the stochastic domination (2), we can now study the expected value of the number of infected drones and towers, which is done in the next two lemmas.

Lemma 3. Assume that (n−2)p<1 and (m−1)q<1. Then,

$${E}_{0} ( {S}_{n} ) \leq 1 + \frac{( n - 1 ) p}{1 - ( n - 2 ) p} and$$

$${E}_{x} ( {\hat{S}}_{x} ) \leq 1 + {\sum }_{k = 1}^{m} ( \frac{k q}{1 - ( k - 1 )} ) P ( D = k ) .$$

Proof. Using (2) and conditioning on the previous generation,

$$\begin{matrix}E ( {X}_{g} ) \leq E ( {ξ}_{g} ) = E ( E ( {ξ}_{g} \vert {ξ}_{g - 1} ) ) = E ( {ξ}_{g - 1} E ( {y}_{2} ) ) = {μ}_{2} E ( {ξ}_{r - 1} ) \\ = {μ}_{2}^{2} E ( {ξ}_{g - 2} ) = = {μ}_{2}^{g - 1} E ( {ξ}_{1} ) = {μ}_{1} E ( {ξ}_{0} ) {μ}_{2}^{g - 1} = {μ}_{1} {μ}_{2}^{g - 1}\end{matrix} \qquad ( 3 )$$

Using (1) and (3), and monotone convergence, we deduce that:

$${E}_{0} ( {S}_{n} ) \leq E ( {\sum }_{g = 0}^{∞} {ξ}_{g} ) = {\sum }_{g = 0}^{∞} E ( {ξ}_{g} ) = 1 + {\sum }_{g = 1}^{∞} {μ}_{1} {μ}_{2}^{g - 1} = 1 + \frac{{μ}_{1}}{1 - {μ}_{2}} = 1 + \frac{( n - 1 ) p}{1 - ( n - 2 ) p}$$

which proves the first part of the lemma.

The expected value of Ŝₓ can be estimated by again comparing the number of infected vertices with a Galton-Watson branching process but using extra conditioning to deal with the randomness of the number of drones. More precisely, conditioning on the random variable Dₓ∈{0, 1, 2, . . . , m} and using the previous upper bound, we get:

$${E}_{x} ( {\hat{S}}_{x} ) = {\sum }_{k = 0}^{m} {E}_{x} ( {\hat{S}}_{x} \vert {D}_{x} = k ) P ( {D}_{x} = k ) \leq {\sum }_{k = 1}^{m} ( 1 + \frac{k q}{1 - ( k - 1 ) q} ) P ( {D}_{x} = k ) = 1 + {\sum }_{k = 1}^{m} ( \frac{k q}{1 - ( k - 1 ) q} ) P ( D = k )$$

which completes the proof of the lemma. □

Applying Lemmas 1-3, we get:

$$E ( {L}_{t} ) = λ t E ( {C}_{n , D} ) = λ t {E}_{0} ( {S}_{n} ) ( E ( C ) + {E}_{x} ( {\hat{S}}_{x} - 1 ) E ( \hat{C} ) ) \leq λ t ( 1 + \frac{( n - 1 ) p}{1 - ( n - 2 ) p} ) ( E ( C ) + {\sum }_{k = 1}^{m} ( \frac{k q}{1 - ( k - 1 ) q} ) P ( D = k ) E ( \hat{C} ) ) \qquad ( 4 )$$

which proves Theorem 1.

To prove Theorem 2, we now deal with the fourth step described above: computing the expected number of infected vertices in a star when the contagion starts from the center. In contrast with the complete graph, the star does not contain any cycles, which makes the exact calculation of the mean possible, as shown in the next lemma.

Lemma 4. Assume that Gx is the star graph. Then, Eₓ(Ŝₓ)=1+qE(D).

Proof. Conditioning on the number of branches Dₓ, we get:

$${E}_{x} ( {\hat{S}}_{x} ) = {E}_{x} ( E ( {S}_{x} \vert {D}_{x} ) ) = {\sum }_{k = 0}^{m} {E}_{x} ( {\hat{S}}_{x} \vert {D}_{x} = k ) P ( {D}_{x} = k ) . \qquad ( 5 )$$

In addition, writing Ĝₓ={y₀=x,y₁, . . . , yₖ} on the event that Dₓ=k, we have:

$${E}_{x} ( {\hat{S}}_{x} \vert {D}_{x} = k ) = {\sum }_{i = 0}^{k} P ( x ↔ {y}_{i} ) = P ( x ↔ x ) + {\sum }_{i = 1}^{k} P ( x ↔ {y}_{i} ) = 1 + kq . \qquad ( 6 )$$

Combining (5) and (6), we conclude that:

$${E}_{x} ( {\hat{S}}_{x} ) = {\sum }_{k = 0}^{m} ( 1 + k q ) P ( {D}_{x} = k ) = 1 + q E ( D )$$

which completes the proof of the lemma.

The estimate in (4) again applies to the out-of-range model except that the expected value of Ŝₓ is now given by Lemma 4. In particular,

$$E ( {L}_{t} ) = λ t E ( {C}_{n , D} ) = λ t {E}_{0} ( {S}_{n} ) ( E ( C ) + {E}_{x} ( {\hat{S}}_{x} - 1 ) E ( \hat{C} ) ) \leq λ t ( 1 + \frac{( n - 1 ) p}{1 - ( n - 2 ) p} ) ( E ( C ) + q E ( D ) E ( \hat{C} ) )$$

which proves Theorem 2. □

To demonstrate the strength and utility of our framework, we apply our framework to the recent and emerging context of drone delivery systems in College Station, TX.

### 6. Example System Implementation for Drone Delivery Fleet (College Station, TX)

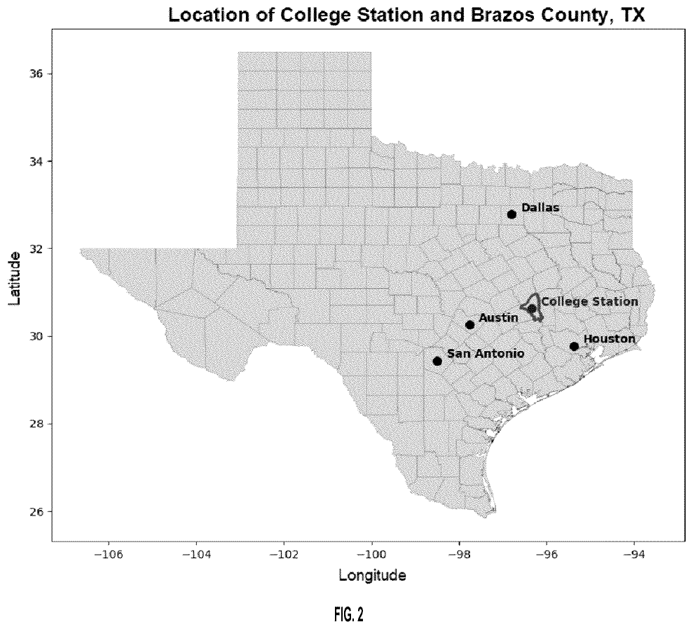

In this section, we apply the systems outlined herein to evaluate cost distribution and size of the random graph in the context of a study area of College Station, TX (see FIG. 2) to illustrate the real-world applicability of this study.

In particular, Amazon recently received new FAA authorization and permissions to expand the drone delivery area in College Station, TX beyond visual line of sight (BVLOS) operations (Amazon, 2024), meaning that drones can operate at greater distances. This expansion enables more Amazon customers to qualify for drone package delivery, highlighting Amazon's continuous and long-term commitment to drone delivery services in this region. Additionally, the area's minimal air traffic contributes to a favorable environment for drone operations. Specifically, there are no airports within the operational vicinity of drone delivery operations (FAA, 2022d), which eliminates the necessity to incorporate midair collisions with aerial aircraft into risk analyses. Lastly, residents need to have backyards to qualify for drone deliveries (Amazon, 2022; Kan, 2022), which excludes certain types of properties, such as apartments and condensed housing developments, from our analyses. Overall, integrating data pertaining to College Station, TX offers a relevant risk assessment framework on the cybersecurity risks and associated monetary losses of drone delivery networks.

TABLE 2
Relevant specifications of selected drone models and corresponding descriptive statistics.

| | Weight | Wingspan | Flight Range | |
|---|---|---|---|---|
| Drone Models | (kg) | (m) | (km) | Source(s) |
| Wing | 4.80 | 1.00 | 20.00 | (Osinto, 2020) |
| Matternet M2 | 13.15 | 1.27 | 20.00 | (FAA, 2022a; Matternet, 2022) |
| Wingcopter GmbH | 24.04 | 1.98 | 75.00 | (FAA, 2022b; Wingcopter, |
| Model 198 US | | | | 2021) |
| Zipline UAS Sparrow | 20.87 | 3.05 | 16.09 | (FAA, 2022c, e) |
| Flirtey F4.5 Unmanned | 17.24 | 1.98 | 16.09 | (FAA, 2022c) |
| Aircraft | | | | |
| Amazon MK27 | 40.37 | 1.98 | 24.14 | (Tarasov, 2022; Federal |
| | | | | Register, 2022) |
| Mean | 20.08 | 1.88 | 28.55 | |
| Median | 19.05 | 1.98 | 20.00 | |
| Standard Deviation | 11.98 | 0.71 | 22.95 | |

### 6.1. Data Considerations

Drone specifications: In this study, we select some of the popular and mainstream drone models used for delivery services (Corrigan, 2020; Frackiewicz, 2023) (see Table 2). For many of the drones, the maximum carry weight of 2.3 kg. This payload capacity is significant because more than 75% of all drone deliveries are under this weight (TechMonitor, 2019; FAA, 2022d).

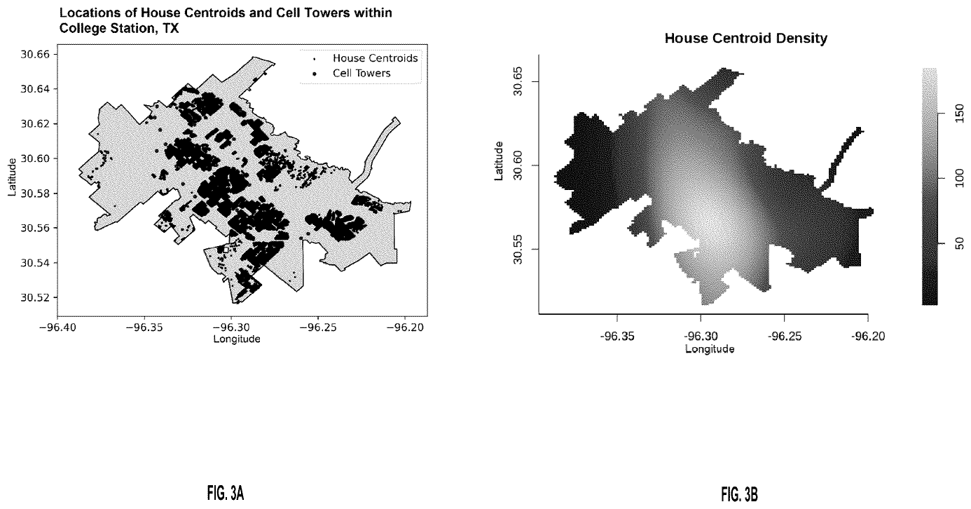

House centroids: The drone delivery service can deliver to eligible customers with a backyard in the city limits of College Station, TX (Amazon, 2022). To integrate this feature into our model, we first collect the eligible residential centroids for drone delivery service within College Station city limits. We leverage building footprints from Microsoft's building dataset (accessed on 28 Sep. 2023) (Microsoft, 2023) to acquire the spatial distribution of potential drone delivery locations. FIGS. 3A and 3B show the resulting map of the house centroids potentially eligible for drone delivery service, which is approximately 17, 869 house centroids. This number may vary due to evolving development and zoning alterations that transpire over time. Nonetheless, it serves as an approximation of house locations, offering a basis for determining the spatial density suitable for eligible drone delivery operations.

TABLE 3
Summary statistics of the distance between cell towers in College Station, TX and the
percentage of cell towers that are in connective range for varying distance thresholds
with the max range being 16 km (Farooq et al., 2022; Koulouris et al., 2023; Zou et al., 2017).

| Cell | | | | Percentage of Cell Towers within Range given | | | |
|---|---|---|---|---|---|---|---|
| Tower | Distance between Cell Towers (km) | | | Distance Threshold | | | |
| Identifier | Mean | Median | Deviation | 16 km | 12 km | 8 km | 4 km |
| 1 | 8.49 | 9.06 | 3.14 | 100.00% | 88.89% | 38.89% | 5.56 % |
| 2 | 5.02 | 4.85 | 1.88 | 100.00% | 100.00% | 88.89% | 27.78% |
| 3 | 3.92 | 3.57 | 1.62 | 100.00% | 100.00% | 100.00% | 61.11% |
| 4 | 4.67 | 4.32 | 3.00 | 100.00% | 100.00% | 88.89% | 44.44% |
| 5 | 4.84 | 4.51 | 3.18 | 100.00% | 100.00% | 88.89% | 38.89% |
| 6 | 3.72 | 3.17 | 2.56 | 100.00% | 100.00% | 88.89% | 72.22% |
| 7 | 3.88 | 2.94 | 2.57 | 100.00% | 100.00% | 88.89% | 66.67% |
| 8 | 5.41 | 4.90 | 1.96 | 100.00% | 100.00% | 83.33% | 22.22% |
| 9 | 8.37 | 9.09 | 3.13 | 100.00% | 100.00% | 38.89% | 11.11% |
| 10 | 4.06 | 3.95 | 1.79 | 100.00% | 100.00% | 100.00% | 50.00% |
| 11 | 4.44 | 4.66 | 1.69 | 100.00% | 100.00% | 100.00% | 38.89% |
| 12 | 5.67 | 4.86 | 3.09 | 100.00% | 94.44% | 77.78% | 33.33% |
| 13 | 4.02 | 2.86 | 2.35 | 100.00% | 100.00% | 88.89% | 61.11% |
| 14 | 4.44 | 4.16 | 3.12 | 100.00% | 100.00% | 88.89% | 50.00% |
| 15 | 3.72 | 3.74 | 2.01 | 100.00% | 100.00% | 88.89% | 72.22% |
| 16 | 5.83 | 5.17 | 3.03 | 100.00% | 94.44% | 72.22% | 33.33% |
| 17 | 4.45 | 4.18 | 1.75 | 100.00% | 100.00% | 100.00% | 33.33% |
| 18 | 4.01 | 3.64 | 2.89 | 100.00% | 100.00% | 88.89% | 61.11% |
| 19 | 5.43 | 5.81 | 2.02 | 100.00% | 100.00% | 88.89% | 27.78% |

Cell tower locations: We compiled spatial coordinates for identified cell towers in College Station, TX, utilizing data from both known sources and the Federal Communications Commission (FCC) registration. For verification, we cross-referenced registered cell towers obtained from (AntennaSearch, 2023) with the Antenna Structure Registration (ASR) records provided by the FCC (Federal Communications Commission (FCC), 2023), thereby enriching our understanding of the spatial coordinates of FCC-registered cell towers in College Station, TX. Considering the maximum range of 4 G LTE, which extends up to 16 km (Farooq et al., 2022; Koulouris et al., 2023; Zou et al., 2017), reveals that the cell towers in College Station, TX exhibit close spatial proximity to one another (see Table 3). Even under a conservative estimation, considering a half range of 8 km, a notable extent of range overlap remains evident among these cell towers. This observation indicates a high spatial interconnection among the towers, motivating the adoption of a mesh network topology discussed in Section 3.

Loss data: To our knowledge, there is no historical drone crash data available, except those from military operations (see e.g. DroneWars, 2022), making it ineffective for accurate drone insurance pricing in a domestic and commercial setting. As a proxy, we leverage historical hail loss data from the Spatial Hazard Events and Losses Database for the United States (SHELDUS) (Center for Emergency Management and Homeland Security, 2023). SHELDUS loss data implicitly accounts for the altitude of the hailstorm event. To begin, we first gather all of the U.S. counties that have similar median 2021 housing prices (approximately a 10% threshold) to that of Brazos County, Texas, where College Station is located. Then, we cross-reference those counties with those in the SHELDUS database, resulting in a dataset of counties that have historical hail loss values and comparable median housing prices to Brazos County. Next, we scale the data by U.S. climate region. Within this data, we consider the property damage per capita adjusted to 2021 dollars, assuming the loss amounts are uniformly distributed across each individual within the county. We multiply by the average population of a county in the U.S. in 2021, which is 105,608, (U.S. Census Bureau, 2023) and divide by the average number of persons per household in Brazos County in 2021, which is 2.57 (Bureau, 2022). Here, we have the property damage per household in 2021 dollars. This value may be adjusted with inflation as needed.

Now, we adjust the property damages of hail to those of drone size. Here, we multiply by the ratio of drone wingspan diameter (39.3701 in) from Table 2 and size diameter of hail (4.5 in) (National Oceanic and Atmospheric Administration (NOAA), 2021). Here, we converted the wingspan from meters to inches for the comparable ratio of standard hail size dimensions. Although rare, we chose this size of hail diameter since it is the largest-sized hail that may be seen in an extreme thunderstorm (National Oceanic and Atmospheric Administration (NOAA), 2021). Thus, it is more closely comparable in size to a drone. Next, we multiply by the ratio of densities of carbon fiber drone (2.00 g/m³) (Dave, 2023; Minus & Kumar, 2005) and 97% of severe hail cases having density (3.28 g/m³) (National Oceanic and Atmospheric Administration (NOAA), 2022). Many drones, such as those used by Amazon (Dave, 2023), incorporate carbon-fiber components in their construction to achieve a balance of strength, durability, and lightweight design, enhancing overall performance and operational efficiency. The resulting cost distribution is fitted to a lognormal distribution (see Table 4).

TABLE 4
The expected and standard deviation of the costs for a single
cell tower and the property damage loss by drone.

Cost

| | E(C) | \sqrt{Var(C)} |
|---|---|---|
| Cell Tower | 0.00 | 0.00 |
| Property damage by drone | 34,962.06 | 13,203.76 |

In summary, Table 4 demonstrates a single drone's cost for estimated property damage per household in 2023 dollars adjusted for U.S. climate, size, and density. This cost materializes when a drone is compromised, resulting in drone failure and falling. In this setting, we only consider the costs associated with property damages by a drone falling to be more relevant for insurance pricing purposes. Therefore, we set the cost of cell towers to zero so that they can only act as connective components in the network for contagion propagation but do not contribute to the aggregate loss distribution characterization. This is motivated by insurers not insuring cell towers themselves. However, insurers may be more interested in the property damages caused by drones falling. Therefore, using the aforementioned proxy of hail and corresponding scaling, we consider the property damages caused by drone failure.

Communication ranges: In order to analyze the Poisson point pattern and generate the drone delivery network instance(s), we carry out distance calculations for the various positions: (i) between drones and cell towers, (ii) between drones, and (iii) between cell towers. If the calculated distance exceeds a predetermined range threshold, an edge formation occurs. The threshold value depends on the specific communication protocol employed. For instance, when considering drone-to-drone communication, we assume the use of Wi-Fi, which has a maximum range of 100 m (Bhatia, 2015; Koulouris et al., 2023). Thus, if two drones are within 100 m of each other, an edge formation occurs. On the other hand, if the distance between two drones exceeds 100 m, no edge formation takes place. We repeat this process for the other drones and cell tower connections. For simplification, we assume that all of these other thresholds are 16 km for a maximum range using 4 G LTE (Farooq et al., 2022; Koulouris et al., 2023; Zou et al., 2017) (see Table 5). To conclude this section, Table 6 provides a list of empirical data assumptions.

TABLE 5
The connectivity range thresholds by protocol between
the drones and cell towers used in the simulations.

| Connectivity | Protocol | Range Threshold (km) |
|---|---|---|
| Drone-to-Drone | Wi-Fi | 0.10 |
| Drone-to-Cell Tower | 4 G LTE | 16.00 |
| Cell Tower-to-Cell Tower | 4 G LTE | 16.00 |

TABLE 6
Summary of data assumptions.

| | | Data |
|---|---|---|
| Topic | Assumptions | Visualization |
| Cell Tower Locations | Cell tower communications operate without any obstructions, ensuring clear and | See Table 3 |
| | uninterrupted signals. | |
| Loss Data | U.S. Counties median 2021 housing prices with 10% difference from Brazos | See Table 4 |
| | County, TX. | |
| | Historical hail loss values from SHELDUS Version 22 for property damage. | |
| | Loss amounts are uniformly distributed across individuals within the county. | |
| | Cell towers have zero loss amounts for propagation purposes. | |
| Communication | Drones use only Wi-Fi with full, unobstructed range capabilities of 0.10 km. | See Table 5 |
| Ranges | Cell towers use only 4 G LTE with full, unobstructed range capabilities of 16 km. | |

TABLE 7
The expected upper bounds of the losses based on Theorem 1 and Theorem 2 for the
drone swarm and out-of-range model, respectively, for varying number of n cell towers.
The drones per cell tower follows [k₀, k₁, k₂, k₃] = [0, 0.4, 0.4, 0.2]. The cost structure
and communication range are in Table 4 and Table 5, respectively. Differing
probabilities of edge contagion are considered, and the simulation results are based
on one million simulations with assumptions t = 1 and λ = 1.

| | p = 0.2, q = 0.2 | | | | p = 0.8, q = 0.8 | | | |
|---|---|---|---|---|---|---|---|---|
| | Drone Swarm | | Out-of-Range | | Drone Swarm | | Out-of-Range | |
| | Analytical | Simulated | Analytical | Simulated | Analytical | Simulated | Analytical | Simulated |
| Cell Towers | E[L]≤ | E[L] | E[L]≤ | E[L] | E[L]≤ | E[L] | E[L]≤ | E[L] |
| 8 | 134, 254.31 | 112, 464.35 | 100, 690.73 | 73, 433.90 | 760, 774.43 | 714, 295.06 | 402, 762.93 | 360, 532.92 |
| 12 | 201, 381.47 | 188, 513.08 | 151, 036.10 | 126, 354.82 | 1141, 161.64 | 985, 967.53 | 604, 144.40 | 579, 996.84 |
| 16 | 268, 508.62 | 229, 143.89 | 189, 248.21 | 145, 248.21 | 1521, 548.85 | 1434, 651.99 | 805, 525.86 | 753, 460.08 |
| 20 | 335, 635.78 | 319, 101.73 | 251, 726.83 | 226, 910.72 | 1901, 936.06 | 1828, 142.88 | 1006, 907.33 | 960, 174.34 |

The results in Table 7 show that the analytical bounds are in relative agreement with the simulation results for the drone swarm and out-of-range models. Within this numerical setting, the difference between simulation and analytical results does not exceed five percent. In addition, in all cases, the low probability of edge contagion (i. e. p=0.2, q=0.2) yields lower loss amounts than the high probability of edge contagion (i. e. p=0.8, q=0.8). Therefore, increasing the cybersecurity measures of the network would reduce the scale of the losses. With this in mind, we will now compare the network configurations of the drone swarm and the out-of-range models for the mean and variance of the losses.

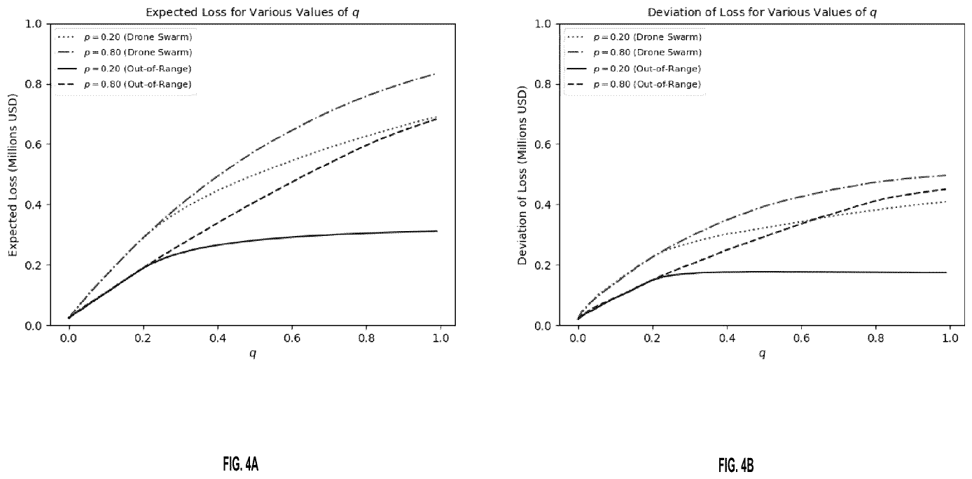

Implication 2: Loss differences of drone deployment: Typically, drone operators, such as Amazon, can only control the cybersecurity of their drone communication network and not the broader components, such as the cell towers. Therefore, the network configuration of their drone deployment may be important for managing cyber risk by reducing the losses. With this in mind, the mean and variance of the aggregate loss for t=1 as a function of the edge contagion probability between drones (q) for various values of edge contagion probability between cell towers (p) can be visualized FIGS. 4A and 4B to better understand the impact of the drone swarm model juxtaposed to the out-of-range model on the losses.

From FIGS. 4A and 4B, the losses are all nondecreasing as expected since lowering the drone network's cybersecurity protection i.e. increasing q or p would yield greater losses. In addition, the greater the cybersecurity protections of the cell towers in both the drone swarm and out-of-range models i.e. p=0.2 yields lower mean and standard deviation of losses. This indicates that cybersecurity protections of broader interconnected components of the drone delivery network, in this case, the cell towers, have an impact on scaling the losses. Furthermore, if one looks closely, the drone swarm model exhibits higher expected losses and deviations compared to the out-of-range model. This discrepancy stems from the varying infected cluster sizes between the fully interconnected mesh network in the drone swarm model and the disconnected clusters in the out-of-range model (refer previously to FIGS. 1A and 1B for visualization). The extensive communication capabilities in the drone swarm model result in larger infected clusters, representing an upper bound on infection spread. Conversely, the out-of-range model, with its limited communication range leading to smaller infected clusters, serves as a lower bound. This trend can also be seen previously in Table 7. Therefore, this supports the drone swarm model being an upper bound for the losses and the out-of-range model being a lower bound of the losses.

By analyzing these bounds, a wide range of stakeholders such as insurers can characterize the losses of a diverse array of drone delivery network configurations, including partial mesh networks, between the drone swarm and out-of-range models. Consequently, our approach provides bounds on the losses across a spectrum of drone operational scenarios. Subsequently, we explore how different sizes of drone operations and varying levels of cybersecurity measures scale the losses.

Implication 3: Various-scale of drone operations: The varying scenarios describe the percentage of house centroids available to receive drone delivery packages in College Station, TX (refer to Section 6.1). In principle, this provides a proxy for the number of drones being deployed at a given time.
Scenario I: Small-scale of drone deployment. The first scenario considers 10% of the house centroids available, which is approximately 1786
Scenario II: Medium-scale of drone deployment. The second scenario considers 50% of the house centroids available, which is approximately 8934 house centroids.
Scenario III: Large-scale of drone deployment. The third scenario considers all of the house centroids available, which is 17,869.

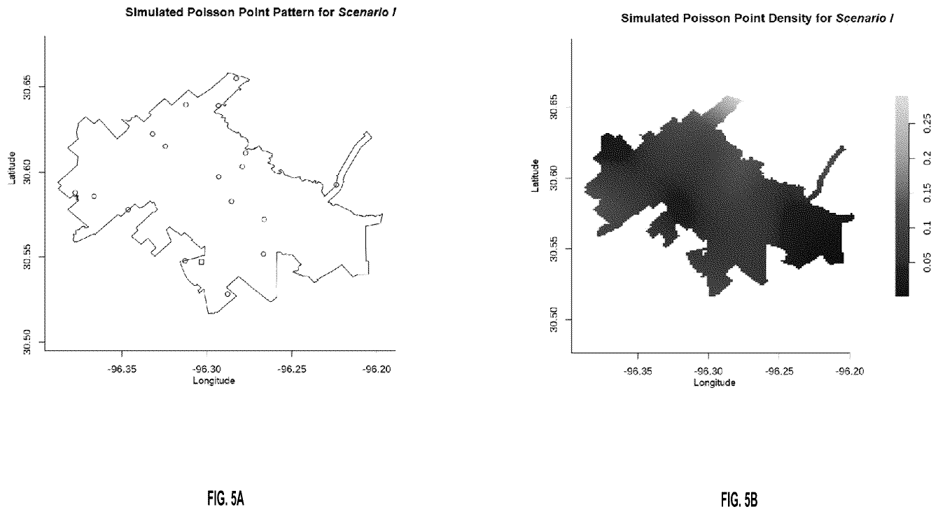

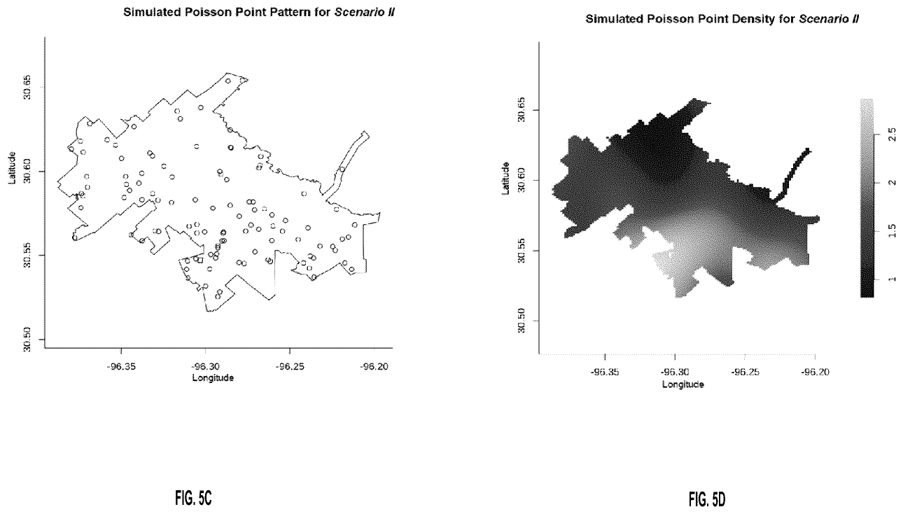

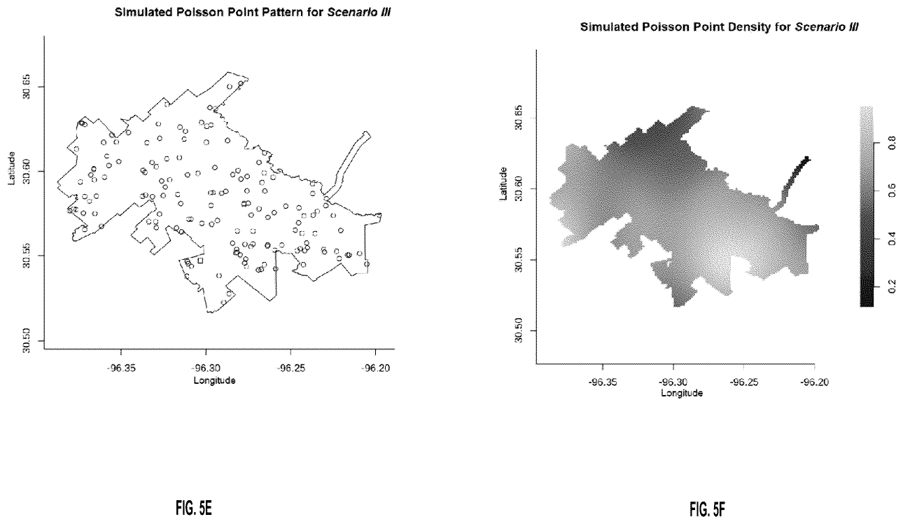

For each scenario, the probability mass function [k₀, k₁, . . . , kₘ] for the distribution of drones per cell tower is adjusted for varying values of m=5, 10, and 15. For example, when m=15, there is a probability of k₁₅ of 15 deployed drones in proximity to the cell tower. In total, the number of drones is 300. The probability is based on the spatial density of house centroids within the cell tower's range. Opting for this approach allows us to investigate a range of deployed drone fleet sizes and locations, leading to stochastic configurations within the drone delivery network (see FIGS. 5A-5F for examples of the simulated Poisson point pattern for Scenario I, II, and III). Assuming no differences in households, we expect to see more drones in denser areas of houses. Finally, through the modification of the probabilities tied to available households, we attain a deeper understanding of the dynamic interaction between the number of drones allocated to each cell tower and the resulting expectations and variations in losses.

TABLE 8
The expectation and deviation of losses for Scenarios I, II, and III for m maximum
number of drones per cell tower. The cost structure and communication range are in
Tables 4 and 5, respectively. Differing probabilities of edge contagion are considered,
and the simulation results are based on one million simulations with assumptions t = 1 and λ = 1.

| | Number of Drones | Edge Contagion | | | | | |
|---|---|---|---|---|---|---|---|
| | per Cell Tower | Probabilities | | Loss Amounts | | Infected Drones | |
| | m | p | q | E[L] | √Var[L] | E[D] | √Var[D] |
| Scenario I | 5 | 0.2 | 0.2 | 611, 836.05 | 148, 457.33 | 17.50 | 3.92 |
| | | 0.8 | 0.8 | 1065, 643.59 | 198, 973.40 | 30.48 | 4.67 |
| | 10 | 0.2 | 0.2 | 1098, 158.30 | 209, 761.35 | 31.41 | 5.58 |
| | | 0.8 | 0.8 | 1911, 026.20 | 269, 202.13 | 54.66 | 7.23 |
| | 15 | 0.2 | 0.2 | 1164, 236.60 | 258, 976.24 | 33.31 | 5.57 |
| | | 0.8 | 0.8 | 1906, 131.51 | 271, 264.57 | 54.52 | 7.24 |
| Scenario II | 5 | 0.2 | 0.2 | 754, 830.88 | 165, 671.12 | 21.59 | 4.25 |
| | | 0.8 | 0.8 | 1296, 742.81 | 210, 635.27 | 37.09 | 5.07 |
| | 10 | 0.2 | 0.2 | 1533, 785.57 | 251, 234.69 | 43.87 | 6.62 |
| | | 0.8 | 0.8 | 2616, 910.19 | 326, 127.84 | 74.85 | 8.77 |
| | 15 | 0.2 | 0.2 | 2293, 181.65 | 402, 778.03 | 65.59 | 11.04 |
| | | 0.8 | 0.8 | 3357, 057.00 | 424, 916.39 | 96.02 | 11.48 |
| Scenario III | 5 | 0.2 | 0.2 | 757, 627.84 | 161, 876.56 | 21.67 | 4.23 |
| | | 0.8 | 0.8 | 1576, 439.29 | 204, 005.75 | 45.09 | 5.02 |
| | 10 | 0.2 | 0.2 | 1535, 533.68 | 252, 751.32 | 43.92 | 6.77 |
| | | 0.8 | 0.8 | 2627, 398.81 | 340, 125.68 | 75.15 | 8.89 |
| | 15 | 0.2 | 0.2 | 2513, 072.87 | 446, 362.45 | 71.88 | 9.14 |
| | | 0.8 | 0.8 | 3960, 152.54 | 482, 531.23 | 113.27 | 12.83 |

There are several findings that can be derived from the numerical results presented in Table 8. First, across all scenarios, the more house centroids eligible for drone delivery, serving as a proxy for the increased probability of drone presence, correlates with greater loss amounts. Secondly, as the range of distribution of drones per cell tower varies with [0,m], the susceptibility of a higher number of drones to potential cyberattacks becomes evident, leading to increased expectations and deviations in losses. Furthermore, considering the diminished cybersecurity safeguards, specifically the escalation of edge contagion probabilities, there is a discernible rise in both the expectation and deviation of infected drones. Consequently, this augmentation contributes to an elevated expectation and deviation in overall losses.

Considering the extensive dimensionality of the model's parameter space and the numerous scenarios, numerous additional numerical investigations could be undertaken. However, such analyses are omitted here due to space constraints and the inherently self-evident influence of the parameters. With the loss provided loss distributions for the purpose of pricing, an insurer can employ known actuarial pricing techniques such as the actuarial fair premium, standard deviation, expectation principles, etc. (Embrechts, 2000; Kaas et al., 2008). Given the provided distribution of infected drones, an insurer may incorporate the loss of the drone and its cargo into the loss distribution for pricing purposes.

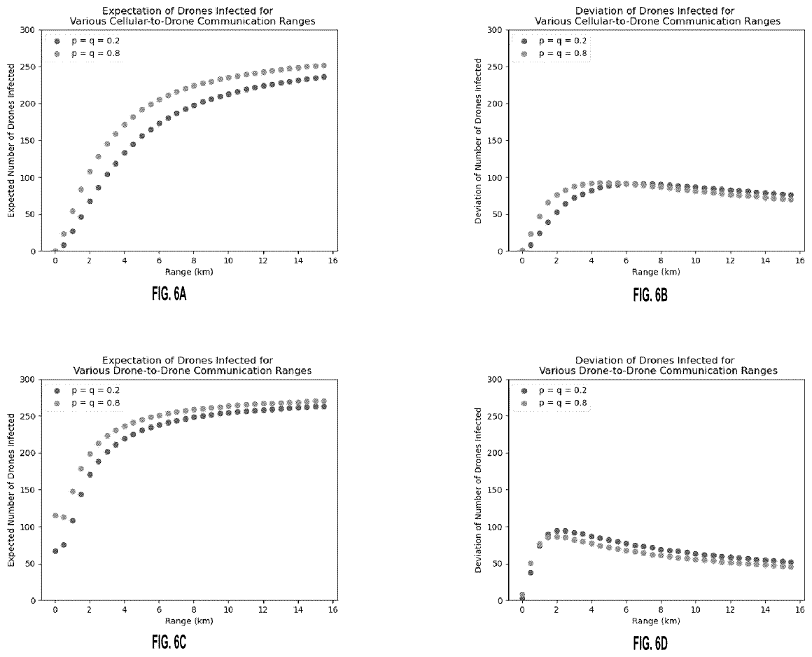

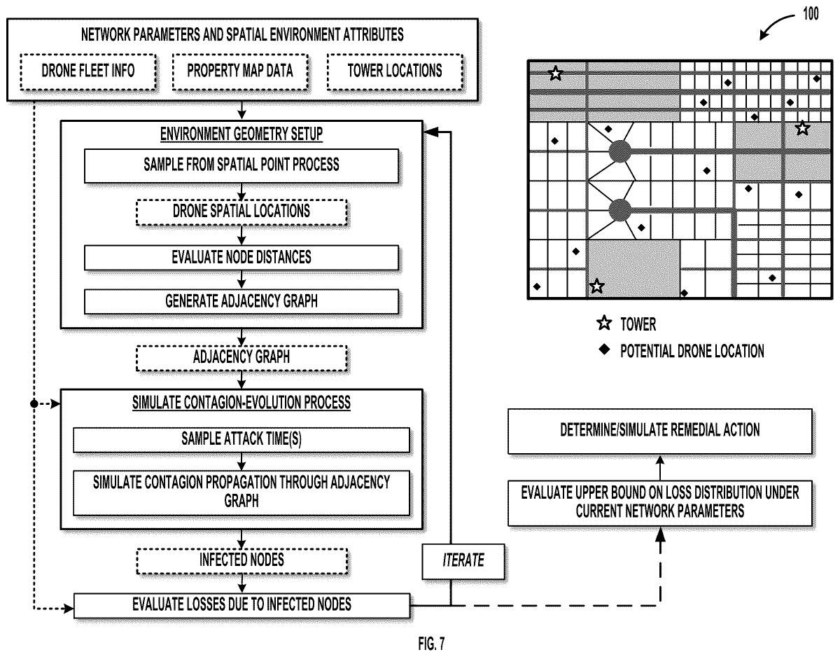

Implication 4: Infected cluster size and communication ranges: Lastly, we investigate the expectation and deviation of infected drones based on varying communication ranges. Recalling from Table 5 where the range communications were static, we vary the communications of drone-to-drone and drone-to-cell tower to investigate how increasing the edge formation may impact the cluster size of infected drones. Two cases of probability of edge contagion were considered: low probability of edge contagion by p=q=0.2 and high probability of edge contagion characterized by p=q=0.8 (see FIGS. 6A-6D).

In all the plots in FIGS. 6A-6D, as the range communication increases, the number of infected drones increases. Similarly, the higher the edge contagion probability i.e. p=q=0.8, the greater the number of infected drones. These findings confirm the trends found in the previous investigations. However, in juxtaposition, the expectation of infected drones for drone-to-drone communications is greater than that of cellular-to-drone communications. This suggests that, in principle, contagion propagation may be more severe between inter-drone communications than between cell towers and drones. In contrast, the deviation of drones infected suggests a shorter tail for the drone to drone compared to cellular and drone. In other words, the number of infected drones is concentrated more around the mean for drone-to-drone communications. Although drone-to-drone communications are significantly shorter (0.1 kₘ) compared to cellular-to-drone (16 kₘ) (refer to Section 2), the findings suggest that the greater edge formation between drones can yield greater losses. This could be useful for insurers to consider as drone communications become more advanced. Hence, from this investigation, insurers should consider the type and range of communication protocols when insuring drone delivery networks. Overall, the geometry, with respect to changing communication ranges, appears to scale the expectation and deviation numbers of infected drones, thereby scaling the loss amounts.

Heterogeneous terrains, such as mountainous or hilly areas, can create communication challenges for drones and cell towers (Burke, 2020; Morales et al., 2020), leading to reduced communication ranges and lower network connectivity. If consistent network connectivity is essential for effective drone operations, then a limited communication range may require the deployment of additional drones, especially in mountainous terrains. In such environments, obstacles such as peaks and valleys can obstruct signals, leading to frequent disruptions and reduced reliability. This may necessitate the deployment of a denser network of drones to ensure that each drone remains within range of a stable communication link.

In contrast, flat terrains typically offer fewer barriers, enabling drones to maintain stronger, more consistent connections with each other and with cell towers. This allows for more efficient operations, as fewer drones may be needed to cover the same area, reducing operational costs and complexity. In the context of this work, the geographical landscape of College Station, TX has an elevation of 87 m and approximately 32 m difference between the minimum (55 m) and maximum (119 m), indicating a relatively flat terrain. To ensure stable communication and connectivity across varying terrains, the number of drones deployed per cell tower can be adjusted to maintain a reliable baseline. This approach forms more multi-layer partial mesh networks with extended network chains of interconnected drones to support continuous connectivity. However, this falls outside the scope of this work and is reserved for future research.

### 8. Discussion

In this paper, we develop a dynamic structural percolation model for the aggregate loss distribution for cyber risk of various-scale drone delivery networks. We impose contagion processes, based on percolation theory, on the drone delivery's network to model a cyberattack. We account for the stochastic nature of drone delivery network topologies by modeling a random number of drones per cell tower. In particular, we investigated two network topologies for drone delivery networks: the drone swarm as a random mesh network and the out-of-range as a random star network. Furthermore, through probabilistic analysis, we characterize the analytical bounds for the mean of loss and the variance of loss via simulation-based methodology to obtain the main aspects of the loss distribution of cyber risk. Characterizing the financial losses of cyber risk can provide valuable insights for enhancing cybersecurity measures and implementing strategies to mitigate such risks effectively. Additionally, our model employs a simulated Poisson point process to generate the random spatial networks representing the locations of the drones without the need to know exactly the path or physical environment of the drone delivery operations. This affords insurers, for example, a new way to assess cyber risk and determine appropriate coverage for varying operational environments. Demonstrating the relevancy and applicability of our framework, we apply it in the context of known and ongoing drone delivery operations in College Station, TX for pricing and risk assessment purposes. And so, with this framework, we reduce the complexity of cyber risk for drone delivery networks and allow for its effective modeling and loss distribution characterization. With the constructed mean and variance, insurers can employ known actuarial pricing principles for drone delivery systems.

Through extensive numerical experiments coupled with our analytical results, we investigate how different measures of cyber security protection in a drone network can affect the scale of the loss distribution. From our findings, drone stakeholders, such as Amazon, should strengthen drone-to-drone communication cybersecurity, but should also consider the cybersecurity of broader network components, like cell towers, as necessary for safe and secure drone delivery operations. Therefore, from an insurance perspective for more accurate cyber risk assessments, insurers should consider the cascading cyber risks across interconnected components, such as cell towers and inter-drone connectivity in drone delivery operations. This observation can be extended to other similar interconnected networks, such as supply chains or interconnected companies. In this setting, our model is well-positioned with other works that estimate the cascading losses of cyberattacks.

Furthermore, we investigate how the network configurations of drone deployment between the two models-drone swarm and out-of-range models-proposed in this paper impact the losses. We found that the drone swarm, modeled as a mesh network of drones per cell tower, yields greater losses than the out-of-range, modeled as a star graph of drones per cell tower. This supports the drone swarm model as an upper bound of the losses and the out-of-range model as a lower bound of the losses. In addition, our framework allows for the loss distribution characterization of a wide array of drone delivery network configurations, including partial mesh networks, between the drone swarm and out-of-range models. Therefore, our framework provides bounds on the losses across various scales of drone operational scenarios.

We also investigate how the size of the drone deployment during a cyberattack can increase the losses. From our findings, the more drones deployed and the more interconnected components in the drone network, such as cell towers, the greater the financial losses. Therefore, drone operators should consider the number of drones deployed for a greater attack surface.

Building upon the aforementioned investigations, we delve deeper into examining how the communication ranges of both drones and cell towers impact the scale of the expectation and deviation of the number of infected drones. From this investigation, we found that increasing the communication range of the drone or cell towers increases the scale of the losses. Thus, drone operators and insurers should closely consider which communication protocols are being used during drone operations.

In summary, this framework offers drone operators, insurers, and cybersecurity experts a means to simulate cyberattacks on drone delivery networks. Such a tool holds significant potential for reducing cyber risks in emerging drone applications, particularly those employing drone swarms. For instance, stakeholders in agriculture are increasingly adopting drone swarms for tasks like seeding and crop spraying, offering cost savings compared to conventional methods (Ruiz, 2024).

Due to the expanding usage of drones, there are ample opportunities for further research following this work. For instance, expanding the impact assessment for drone fall trajectory could provide valuable insights into safety and risk management. Additionally, investigating locations with varying densities of cell towers presents a promising avenue for exploring network resilience and performance in diverse environments. Other network structures could be explored, such as enabling drones to communicate with multiple cell towers simultaneously to form complex, multi-layered mesh networks. Furthermore, integrating the study of compound physical and cyber threats such as wind and cyberattacks represents another important direction, contributing to a more comprehensive understanding of the challenges faced by drone delivery operations.

### Computer-Implemented System

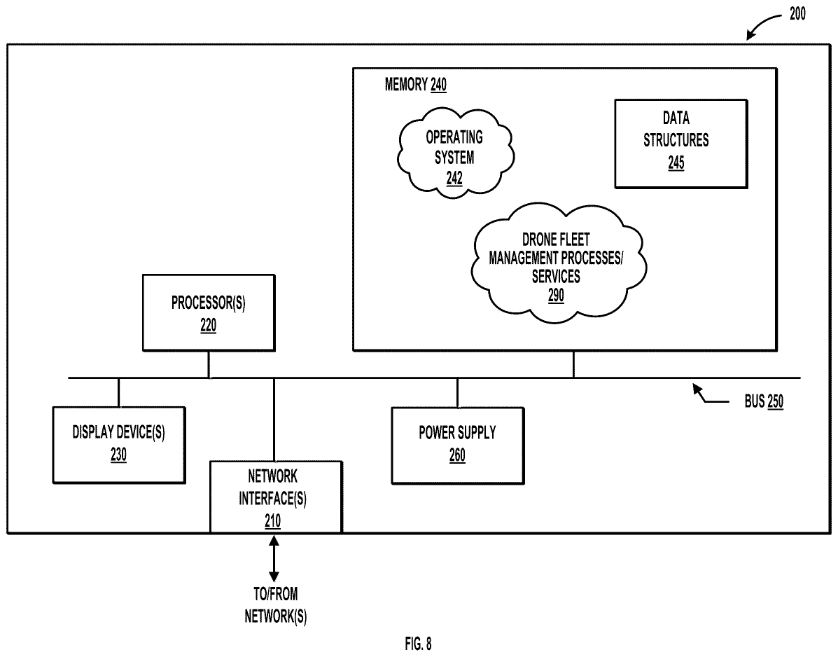

FIG. 7 shows an embodiment of a computational framework 100 for anticipating and mitigating the effects of a cyber attack on a delivery drone fleet, as outlined above. Computational framework can be implemented at a computing device (e.g., computing device 200 shown in FIG. 8 discussed further herein), and can be used to evaluate and optimize drone delivery network deployment protocols with respect to a spatial environment (e.g., a delivery neighborhood).

A processor implementing the computational framework 100 accesses network parameters and spatial environment attributes, including one or more parameters of the network including drone fleet information indicative of physical attributes of one or more drones of the network, spatial location data of one or more tower nodes of the network, and property map data. Property map data can also include cost liability information that correlates with potential property damage costs. As discussed above, in an example implementation hail damage data may be used as a proxy for cost liability information, scaled with respect to the physical attributes of one or more drones.

Because of the stochastic nature of the drone locations during a delivery cycle, the processor sets up a possible environment geometry scenario that subsequently forms a basis for simulation. In particular, the processor: (1) samples spatial locations for a plurality of drone nodes of the network from a spatial point process (e.g., a spatial Poisson Point Process) having an intensity function constructed from property map data and spatial location data of the one or more tower nodes; and (2) generates an adjacency graph (see, e.g., FIGS. 1A and 1B) including an edge between a pair of nodes (e.g., tower-to-tower, tower-to-drone, or possibly drone-to-drone if the network follows a drone swarm topology) based on distance-based thresholding associated with a communication protocol between the pair of nodes (i.e., if two nodes are within communication range and able to talk to one another, then the processor assigns an edge within the adjacency graph. Each edge is assigned an activation probability value (e.g., p or q) indicative of a contagion pathway between the pair of nodes. The activation probability values may be sampled from a predefined distribution.

The pair of nodes of the network can include a first tower node and a second tower node, and the communication protocol between the first tower node and a second tower node having a first range value for distance-based thresholding (e.g., 16 km for LTE). The pair of nodes of the network can alternatively include a tower node and a drone node, and the communication protocol between the tower node and the drone node having the first range value for distance-based thresholding. Further, where the network has a drone swarm topology, the pair of nodes of the network can include a first drone node and a second drone node, and the communication protocol between the first drone node and the second drone node having a second range value (e.g., 100m over WiFi) for distance-based thresholding.

Following setup of the environment geometry scenario, the processor: (3) generates, by iterative simulation of a contagion-evolution process on the adjacency graph using a stochastic state-transition model (e.g., a Markov chain), a set of infected nodes of the network and an accumulated loss value of the set of infected nodes. During simulation of the contagion-evolution process, the processor samples an attack time and origin point and simulates contagion propagation through the adjacency graph from the origin point.

The accumulated loss value incorporates a drone loss value sampled from a drone loss distribution, conditioned on a spatial location and one or more physical attributes of an infected drone node of the set of infected nodes. The drone loss value especially correlates with an expected property damage value resulting from failure of the infected drone node at the spatial location, which can be further affected by physical attributes of the infected drone node such as a mass of the infected drone node and a geometric envelope of the infected drone node. The accumulated loss value can also incorporate a tower loss value for an infected tower node of the set of infected nodes.

The processor can iteratively repeat steps (1)-(3) over a plurality of simulation trials: sampling new spatial locations for each drone of the network, generating new adjacency graphs based on the new spatial locations, and simulating the contagion-evolution process on the new adjacency graphs to obtain a set of infected nodes and associated damage costs (accumulated loss). The processor can evaluate an upper bound of an average loss distribution across the plurality of simulation trials.

In a further aspect, the processor may determine and possibly simulate the effects of a remedial action, such as adjusting one or more drone deployment protocols based on the loss distribution and/or one or more parameters of the network based on spatial location. For example, the processor may determine a limit on one or more parameters of the network to reduce accumulated loss, such as a maximum node quantity permitted within communication range of one another or a maximum communication range permitted between the pair of nodes (e.g., for an area where liability costs may be very high, reduce the allowable communication distance between nodes or reduce the quantity of drones allowed within the area). The processor can also or alternatively generate, test, and adjust a delivery schedule. In some examples, the processor can generate and transmit a control input to one or more nodes to adaptively update network parameters/protocols followed by the drone fleet in real-time to reduce anticipated losses based on a delivery schedule, network geometry, weather alerts, warnings, and the like.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

FIG. 8 is a schematic block diagram of an example device 200 that may be used with one or more embodiments described herein, e.g., implementing aspects of the computational framework 100 of FIG. 7.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.). Device 200 can also include or otherwise communicate with a display interface device 230 which can include one or more input/output devices that enable a user to input data, and to view or otherwise access output data. Input/output devices can include but are not limited to a monitor, a touch-screen, a speaker, a keyboard, a mouse, and the like.

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the computational framework 100 and the methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include drone fleet management processes/services 290, which can include aspects of the methods and/or implementations of various modules described herein with respect to computational framework 100. Note that while drone fleet management processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the drone fleet management processes/services 290 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions executable by the processor to:
(1) sample, from a spatial point process having an intensity function constructed from property map data and spatial location data of one or more tower nodes of a network, spatial locations for a plurality of drone nodes of the network;
(2) generate an adjacency graph including an edge between a pair of nodes of the network based on distance-based thresholding associated with a communication protocol between the pair of nodes, each edge being assigned an activation probability value indicative of a contagion pathway between the pair of nodes; and
(3) generate, by simulation of a contagion-evolution process on the adjacency graph using a stochastic state-transition model, a set of infected nodes of the network and an accumulated loss value of the set of infected nodes, the accumulated loss value incorporating a drone loss value sampled from a drone loss distribution conditioned on a spatial location and one or more physical attributes of an infected drone node of the set of infected nodes.

2. The system of claim 1, the memory further including instructions executable by the processor to:
access the property map data, the spatial location data of the one or more tower nodes, and one or more parameters of the network including drone fleet information indicative of physical attributes of one or more drones of the network;
iteratively repeat steps (1)-(3) over a plurality of simulation trials; and
evaluate an upper bound of an average loss distribution across the plurality of simulation trials.

3. The system of claim 1, the memory further including instructions executable by the processor to:
adjust one or more drone deployment protocols based on a loss distribution across one or more simulation trials.

4. The system of claim 3, the memory further including instructions executable by the processor to:
determine a limit on one or more parameters of the network to reduce accumulated loss.

5. The system of claim 4, the one or more parameters including a maximum node quantity permitted within communication range of one another.

6. The system of claim 4, the one or more parameters including a maximum communication range permitted between the pair of nodes.

7. The system of claim 4, the memory further including instructions executable by the processor to:
adjusting the one or more parameters of the network based on a spatial location of a node of the pair of nodes.

8. The system of claim 1, the pair of nodes of the network comprising a first tower node and a second tower node, and the communication protocol between the first tower node and a second tower node having a first range value for distance-based thresholding.

9. The system of claim 1, the pair of nodes of the network comprising a tower node and a drone node, and the communication protocol between the tower node and the drone node having a first range value for distance-based thresholding.

10. The system of claim 1, the network having a drone swarm topology, and the pair of nodes of the network comprising a first drone node and a second drone node, and the communication protocol between the first drone node and the second drone node having a second range value for distance-based thresholding.

11. The system of claim 1, the one or more physical attributes of the infected drone node including one or more of: a mass of the infected drone node and a geometric envelope of the infected drone node.

12. The system of claim 1, the drone loss value being conditioned on the spatial location of the infected drone node correlating with an expected property damage value resulting from failure of the infected drone node at the spatial location.

13. The system of claim 1, the accumulated loss value incorporating a tower loss value for an infected tower node of the set of infected nodes.

14. A method for simulating losses of a drone delivery fleet due to cyberattacks, comprising:
providing a processor operable for executing instructions including:
(1) sampling, from a spatial point process having an intensity function constructed from property map data and spatial location data of one or more tower nodes of a network, spatial locations for a plurality of drone nodes of the network;
(2) generating an adjacency graph including an edge between a pair of nodes of the network based on distance-based thresholding associated with a communication protocol between the pair of nodes, each edge being assigned an activation probability value indicative of a contagion pathway between the pair of nodes; and
(3) generating, by simulation of a contagion-evolution process on the adjacency graph using a stochastic state-transition model, a set of infected nodes of the network and an accumulated loss value of the set of infected nodes, the accumulated loss value incorporating a drone loss value sampled from a drone loss distribution conditioned on a spatial location and one or more physical attributes of an infected drone node of the set of infected nodes.

15. The method of claim 14, further comprising:
iteratively repeating steps (1)-(3) over a plurality of simulation trials; and
evaluating an upper bound of an average loss distribution across the plurality of simulation trials.

16. The method of claim 14, further comprising:
adjusting one or more drone deployment protocols based on a loss distribution across one or more simulation trials.

17. The method of claim 14, the pair of nodes of the network comprising a first tower node and a second tower node, and the communication protocol between the first tower node and a second tower node having a first range value for distance-based thresholding.

18. The method of claim 14, the pair of nodes of the network comprising a tower node and a drone node, and the communication protocol between the tower node and the drone node having a first range value for distance-based thresholding.

19. The method of claim 14, the network having a drone swarm topology, and the pair of nodes of the network comprising a first drone node and a second drone node, and the communication protocol between the first drone node and the second drone node having a second range value for distance-based thresholding.

20. The method of claim 14, the drone loss value being conditioned on the spatial location of the infected drone node correlating with an expected property damage value resulting from failure of the infected drone node at the spatial location.
